(19) United States
(12) Patent Application Publication
(10) Pub. No.: US 2004/0058059 A1
(43) Pub. Date: Mar. 25, 2004

(54) Funtionalized patterned surfaces

(76) Inventors: Mathew Richard Linford, Orem, UT (US); David Berges, Provo, UT (US); Travis Niederhauser, Provo, UT (US); Adam T. Woolley, Orem, UT (US); Yit-Yian Lua, Provo, UT (US)

Correspondence Address: FISH & RICHARDSON PC, 225 FRANKLIN ST, BOSTON, MA, 02110, US

(21) Appl. No.: 10/416,100

(22) PCT Filed: Nov. 7, 2001
(86) PCT No.: PCT/US01/51030

(51) Int. Cl. B05D 5/12

(52) U.S. Cl. 427/58

(57) ABSTRACT

A method of functionalizing the surface of material, such as a semiconductor or insulator is described. The method includes scribing the surface of the material in the present of a reactive species to produce acribed portions of the surface. The reactive species reacts with the scribed portions of the surface.

### BACKGROUND

This invention relates to functionalizing surfaces. Surface modification has become extremely important in a variety of fields, including biology, chemistry, and materials science. Functionalized surfaces, such as silicon surfaces, are useful in a wide variety of technologies.

Optimizing a formulation or procedure for preparing coatings can require the manufacture of numerous surfaces. This process can be time consuming and can require the use of large amounts of materials. In addition, many processes for modifying surfaces are cumbersome, often requiring high vacuum conditions to avoid unwanted contamination and oxidation, and expensive equipment. It can thus be difficult to prepare modified surfaces.

### SUMMARY

The invention features straightforward methods for functionalizing different surfaces. In some embodiments, the surfaces can be modified under ambient conditions. For example, surfaces can be modified by forming miniature hydrophobic corrals or enclosures on the surfaces. Chemical reactions can then be performed in these miniature enclosures. Alternatively, the interiors of the corrals can be functionalized in a variety of useful ways.

In one aspect, the invention features a method of functionalizing the surface of a material. The method includes scribing the surface of the material in the presence of a reactive species to produce scribed portions of the surface, wherein the reactive species reacts with the scribed portions of the surface, and wherein the material is a semiconductor or an insulator. The reactive species can be in the liquid state; in the vapor state; or dissolved in an organic solvent. The material can be scribed in the presence of air; under a pressure of about 760 torr to about 10⁻¹⁰ Torr; or scribed in an inert atmosphere (e.g., nitrogen or argon) at about atmospheric pressure.

The reactive species can be selected from the group consisting of alkenes, alkynes, alcohols, thiols, amines, halides, aldehydes, ketones, amides, carboxylic acids, carboxylic acid esters, acrylates, methacrylates, vinyl ethers, acrylamides, azides, nitrites, dienes, trienes, phosphines, isocyanates, isothiocyanates, silanols, oximes, diazo, epoxides, nitro, sulfate, sulfonate, phosphate, phosphonate, anhydrides, guanadino, phenolics, acid chlorides, imines, diols, triols, hydrazones, hydrazines, disulfides, sulfides, sulfones, sulfoxides, peroxides, ureas, thioureas, carbamates, diazonium, azo, DNA, RNA, protein, carbohydrates, lipids, and styrenics. The reactive species can have at least one chiral center. It can also be an inorganic compound. Specific examples include 1-alkenes, 1-alkynes, terminal alcohols of the form HO(CH₂)ₙCH₃, where n is 0 or greater, a terminal alkyl halides of the form X(CH2)ₙCH₃, where n is 0 or greater and X is I, Br, or Cl, and terminal carboxylic acids of the form HOOC(CH₂)ₙH, where n is 0 or greater.

The reactive species can contain two or more functional groups, at least one of which is capable of reacting with the surface. The functional groups may be the same or different. The reactive species can be of the form X(CH₂)ₙY, where n is an integer greater than 0 and X and Y represent functional groups. The functional groups can be attached to a phenyl ring.

The material can be scribed under a mixture of two or more reactive species. The scribed portions of the surface can contain free radicals and/or double bonds. The material may contain silicon, quarts, germanium, diamond, silicon carbide, silicon nitride, or a polymer. The material may be hydrogen-terminated silicon, and it may have a curved surface. The material may be coated with a silane; with a silane coupling agent; with a polyelectrolyte multilayer; or with a monolayer.

The material can be scribed with an instrument that makes a mark that is 0.1 mm to 1 cm wide in a single pass; with a tungsten-carbide ball; with an AFM tip; or with a laser.

In another aspect, the invention features a method of functionalizing the surface of a material. The method includes: (a) exposing the surface to a mixture of an inert gas (e.g., nitrogen or argon) and a reactive species; and (b) scribing the surface of the material in the presence of the mixture to produce scribed portions of the surface, wherein the reactive species reacts with the scribed portions of the surface, and wherein the material is a semiconductor or an insulator. The mixture can be directed onto the surface in a gas stream.

In another aspect, the invention features a method of forming a pattern on a surface of a material, including scribing a pre-determined pattern on the surface in the presence of a reactive species to form scribed portions of the surface, wherein the reactive species reacts with the scribed portions of the surface, and wherein the material is a semiconductor or an insulator. The pattern may be a grid; it may contain patches or lines. The material can be silicon, e.g., hydrogen-terminated silicon. The material can also be quartz, diamond, or a polymer.

In another aspect, the invention features a method of functionalizing the surface of a material. The method includes: (a) scribing the surface of the material in an inert atmosphere (e.g., argon or nitrogen) to produce scribed portions of the surface, wherein the material is a semiconductor or an insulator; and (b) exposing the scribed surface to a reactive species, wherein the reactive species reacts with the scribed portions of the surface. The material can be scribed under reduced pressure. The material can be scribed with a diamond scribe; a beam of ions; a beam of energetic neutral species; or a laser. The surface may be patterned; such a surface can be used for chromatography or electrophoresis.

In another aspect, the invention features a composition including a material containing a pattern scribed on its surface, wherein the pattern comprises molecules covalently bonded to the surface, wherein the molecules may contain functional groups, and wherein the material is a semiconductor or an insulator. The material may be silicon or quartz. The pattern may be a grid of may contain patches or lines.

In another aspect, the invention features a composition comprising a material containing a pattern scribed on its surface, wherein the pattern comprises polymer chains covalently bonded to the surface, wherein the material is a semiconductor or an insulator.

In another aspect, the invention features a method of performing a chemical reaction. The method includes: (a) providing a surface containing at least one hydrophobic corral; (b) depositing a drop of solution into each corral; and (c) maintaining the surface under conditions and for a time sufficient to allow the reaction to proceed. The surface can contain Si—C bonds.

In another aspect, the invention features method of performing a chemical reaction. The method includes: (a) providing a surface containing one or more functionalized, scribed regions; (b) depositing a reactant onto at least one of the regions; and (c) maintaining the surface under conditions and for a time sufficient to allow the reaction to proceed. The reactant can be CrO₃/H₂SO₄; Cl₂ gas that is illuminated with UV light; Cl₂ gas and at least one other reactive gas that is illuminated with UV light; or photobiotin.

In another aspect, the invention features a method of functionalizing multiple regions of a surface. The method includes: (a) providing a surface containing a grid of hydrophobic corrals; (b) depositing at least two different solutions into at least two hydrophobic corrals; and (c) maintaining the surface under conditions and for a time sufficient to allow surface functionalization to proceed. Aliquots of two or more liquids can be added to a hydrophobic corral. The liquids may be mixed. In addition, the surface may be cleaned after surface functionalization.

In another aspect, the invention features a method of performing reactions in droplets of solutions in multiple regions of a surface. The method includes: (a) providing a surface containing a grid of hydrophobic corrals; (b) depositing at least two different solutions into at least two different hydrophobic corrals; and (c) maintaining the surface under conditions and for a time sufficient to allow the reactions to occur. The droplets can be analyzed with an analytical technique. The aliquots of at least two different liquids can be added to the same hydrophobic corral. The liquids may be mixed.

In another aspect, the invention features a method of functionalizing different regions of a material, wherein the material is a semiconductor or insulator. The method includes: (a) wetting the dry surface of the material with a reactive compound; (b) scribing a region of the surface; (c) removing the reactive compound; and (d) repeating steps (a)-(c) using a different reactive compound and scribing in a region where scribing has not taken place until the desired functionalization is complete.

In another aspect, the invention features a composition containing a material containing an array of hydrophobic corrals, wherein the interior regions of the hydrophobic corrals are functionalized. The interior regions may contain DNA; RNA; proteinaceous materials; carbohydrates; lipids; polymers; a polyelectrolyte multilayer; a silane coupling agent; or a monolayer.

By “scribing” is meant contacting a portion, i.e., less than the whole, of a surface to chemically activate it. The amount of the surface scribed depends on the application. Up to 99% of the surface may be contacted to derivatize an entire surface. Preferably, less than 90% or less than 75% of the surface is contacted. In the case of patterning a surface with lines or fine features, less than 50% and preferably less than 10% of the surface will be contacted.

By “reactive species” is meant a compound that is capable of reacting with a scribed surface. An example of a reactive species is a compound with a functional group capable of reacting with a radical.

By “insulator” is meant a material that is a poor conductor of electricity; the normal energy band of an insulator is full and is separated from the first excitation band by a gap that can be penetrated only by an electron having an energy of 5 electron volts or greater. Examples of insulators include materials that may exist as crystals such as carbon (diamond), polymers such as polyethylene, polypropylene, polymethylmethacrylate, or polystyrene, and materials that may exist in crystalline, semicrystalline, or amorphous forms, such as quartz. Intrinsic (undoped) silicon may be considered to be an insulator, although silicon is generally classified as a semiconductor.

By “semiconductor” is meant a solid material whose electrical conductivity is intermediate between that of a conductor and an insulator. According to the CRC (2000-2001) the highest occupied energy band (valence band) of a semiconductor is completely filled with electrons at T=0 K, and the energy gap to the next highest band (conduction band) ranges from 0 to 4 or 5 electron volts. With increasing temperature electrons are excited into the conduction band, leading to an increase in the electrical conductivity. Examples include silicon, germanium, gallium arsenide, indium tin oxide, amorphous silicon, and indium phosphide. The conductivity of a semiconductor can often be controlled by doping it.

The invention offers numerous advantages. For example, scribing is advantageous because it is very flexible—corrals of any size (e.g., square or rectangle or other shape)—can be made as desired. Scribing materials such as silicon is desirable because of the known useful chemistry possible with silicon, i.e., silane and Si—H chemistry. In addition, the resulting products, which include scribed semiconductors and insulators, are very useful materials.

Using the methods described herein, one can take a single surface and put different monomolecular (or thicker) layers onto distinct regions of it, i.e., distinct areas, patches, lines, or patterns with desired functionality can be specifically created on surfaces. The methods can thus be used to functionalize a surface with multiple, precisely located coatings in a straightforward manner. The entire process can been automated—for example, a computer can be used to control three translation stages to move a spring-loaded diamond tip across a surface.

The resulting functionalized arrays could be used as replacements for traditional micro lates in biological assays, to optimize organic surface transformations and organic reactions, to make combinatorial libraries for drug discovery and to optimize polymer coatings and formulations. The invention thus provides a way to more quickly screen a large set of reaction conditions on a single surface by providing a method to selectively functionalize certain regions of it.

This invention also demonstrates a novel way to functionalize surfaces and to use that novel functionalization to subdivide a surface into many small regions, which are separated by narrow hydrophobic boundaries such that drops of water or other liquids that are put into these miniature domains do not come into contact with each other. These enclosures will be referred to as “hydrophobic corrals.”

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a scheme showing a scribed silicon surface.

FIG. 2 is a scheme showing binding between reactive species and a silicon surface.

FIG. 3 is a plot showing XPS spectra of scribed silicon.

FIG. 4 is a plot showing the Si 2p narrow scans for the spectra shown in FIG. 3.

FIG. 5 is a scheme showing the reaction of a reactive species with scribed silicon.

FIG. 6 is a plot showing TOF-SIMS spectra of haloalkanes.

FIG. 7 is a plot showing XPS spectra of scribed silicon.

FIG. 8 is a graph showing the ratio of areas of C1s to Si2p XPS peaks and the ratio of O atoms per alkyl chain.

FIG. 9 is a series of plots showing TOF-SIMS spectra of scribed silicon.

FIG. 10 is a graph showing the ratio of the areas of O1s to Si2p peaks from scribed silicon.

FIG. 11 is a plot showing XPS spectra of scribed silicon.

FIG. 12 is a graph showing the fit between theoretical calculations and experimental data regarding film thickness.

FIG. 13 is a scheme showing creation of micromachined chromatography columns.

FIG. 14 is a plot showing XPS spectra of silicon.

FIG. 15 is a graph showing ratio of carbon peak area to silicon peak area.

FIG. 16 is a graph showing the ratio of areas of uncorrected C1s peaks to Si2p peaks.

FIG. 17 is a set of graphs showing relative intensities of signals corresponding to SiCH₃⁺ is a function of carbon number.

FIG. 18 is a set of graphs showing relative intensities of signals corresponding to SiC₂H₅⁺ as a function of carbon number.

FIG. 19 is a set of graphs showing relative intensities of signals corresponding to SiC₃H₇⁺ as a function of carbon number.

FIG. 20 is a set of graphs showing relative intensities of signals corresponding to SiC₄H₉⁺ as a function of carbon number.

FIGS. 21, 22, and 23 are sets of graphs showing relative intensities of SiCₙH₂ₙ₊₁⁺ signals for various species.

FIG. 24 is a set of graphs showing relative intensities of signals corresponding to SiC₃H₇⁺ as a function of carbon number.

FIG. 25 is a set of ToF-SIMS spectra of scribed silicon.

FIG. 26 is a graph showing passing and failing surface tensions of droplets in hydrophobic corrals.

FIGS. 27 and 28 are graphs showing XPS measurements of scribed patches with reactive species of different carbon lengths.

### DETAILED DESCRIPTION

For many materials, the act of scribing, e.g., abrading or scratching, will produce highly reactive surface species, such as free radicals. If a material is scribed in the presence of a reactive molecule, it may be simultaneously functionalized and patterned.

Functionalization can take place in air or an inert atmosphere. The results described herein suggest that when a material such as silicon is scribed in the presence of a reactive species, a chemical reaction takes place between the reactive molecule and the exposed surface, forming a covalent bond. Applicants do not, however, wish to be bound by any theories put forth herein.

Generally, any substrate that can be scratched can be used. Different forms of silicon can be used, e.g., different dopants and doping levels and crystal structures ((100), (111), (110)), or even amorphous silicon. Examples of other materials include, but are not limited to, quartz, glass, polymers, diamond, and minerals such as mica. Other substrates include plastic, glassy polymers such as polycarbonate and polymethylmethacrylate, germanium, silicon carbide, mica, quartz, and other minerals.

A wide variety of reactive species will functionalize semiconductors and insulators, such as silicon, when the material is scribed in the presence of the reactive species. These include classes of compounds that are known to react under ultrahigh vacuum conditions with clean unpassivated silicon, such as alkenes, alkynes, alkyl halides, and alcohols. Unsaturated monomers also appear to react with the exposed surface. There are a number of other functional groups that may react including, but not limited to, silanes (especially those that are hydrolyzed to contain the —OH group), amines, thiols, amine oxides, oximes, ketones, epoxides (oxiranes), aldehydes, carboxylic acids, esters, amides, lactones, lactams, nitriles, ethers, thioethers, disulfides, diacylperoxides, dialkylperoxides, and alky- or arylperoxides.

One class of compounds that can be used to functionalize surfaces is alkenes. Any molecule with a double bond is of interest, including those with terminal double bonds, e.g., α-olefins, H₂C═CH(CH₂)ₙCH₃, as well as those with double bonds in other positions in a molecule. Terminally functionalized alkenes could be of the general formula: H₂C═CH(CH₂)ₙX, where X could be —NH₂, —COOH, —COOR, —CONH₂, —OH, —NR₃⁺, -epoxy, -glycidyl, —C₆Hs, —C₆H₄COOH, —C₆H₄OH, —C₆H₄NH₂, -protein, -biotin, -DNA, -RNA, -PEG, -a living cell, or some other moiety. Alternatively, α,ω-functionalized alkenes having the formula H₂C═CH(CH₂)ₙCH═CH₂ can be used.

Often, the reaction between the surface of the material and the alkene results in a hydrophobic section of the surface. It is thought that alkenes could bind to a surface such as silicon through one or two C—Si bonds. Perfluorinated or partially fluorinated alkyl chains, e.g., H₂C═CH(CF₂)ₙCF₃, can be used to lower the surface tension of hydrophobic portions to a level below that possible with hydrocarbons. Another possibility is to use polymers that contain unsaturated groups such as siloxane polymers with pendant vinyl groups, e.g., poly(butadiene), poly(isoprene), or maleinized butadiene.

Another class of reactive compounds that can be used to functionalize surfaces is alkynes. The triple bond can be anywhere in the molecule, including the terminal position of an alkyl chain: HC≡C(CH₂)ₙCH₃. Terminally functionalized alkynes of the general formula HC≡C(CH₂)ₙX, where X could be —NH₂, —COOH, —COOR, —CONH₂, —OH, —NR₃⁺, -epoxy, -g lycidyl, —C₆H₅, —C₆H₄COOH, —C₆H₄OH, —C₆H₄NH₂, -protein, -biotin, -DNA, -RNA, -PEG, -a living cell, or some other functional group or moiety can also be used. One could also employ α,ω-functionalized alkynes having the formula HC≡C(CH₂)ₙC≡CH. In addition, perfluorinated or partially fluorinated alkyl chains, e.g., HC≡C(CF₂)ₙCF₃, can be used to lower the surface tension of hydrophobic lines to a level below that possible with hydrocarbons. It is thought that alkynes could bind to surfaces such as silicon through one or more C—Si bonds.

Reactive monomers can also be used to functionalize the surface. Categories of such monomers include the acrylates, methacrylates, styrenics, derivatives and analogs of butadiene, maleic anhydride and maleic acid esters, vinyl ethers, acrylamide and its derivatives, monomers containing fluorinated or partially fluorinated alkyl chains, nitriles, metal salts of acrylic acid and methacrylic acid, vinylidine and vinyl monomers. Specific examples of such monomers include acrylic acid, methyl acrylate, ethyl acrylate, hydroxyethyl acrylate, butyl acrylate, lauryl acrylate, octadecyl acrylate, 2-(dimethylamino)ethyl acrylate, acryloyl chloride, methacrylic acid, methyl methacrylate, ethyl methacrylate, hydroxyethyl methacrylate, butyl methacrylate, lauryl methacrylate, octadecyl methacrylate, 2-(dimethylamino)ethyl methacrylate, methacryloyl chloride, methacrylic anhydride, monomers with more than one acrylate or methacrylate group on them, derivatives of poly(ethylene glycol) that contain 1 or more acrylate or methacrylate group, styrene, 2-bromostyrene, 3-bromostyrene, 4-bromostyrene, 2-chlorostyrene, 3-chlorostyrene, 4-chlorostyrene, 2-fluorostyrene, 3-fluorostyrene, 4-fluorostyrene, 4-aminostyrene, divinylbenzene, 4-styrenesulfonic acid (sodium salt), butadiene, isoprene, maleic anhydride, maleic acid, methyl vinyl ether, ethyl vinyl ether, allyl vinyl ether, dodecyl vinyl ether, octadecyl vinyl ether, acrylamide, methacrylamide, N,N-dimethylacrylamide, N-isopropylacrylamnide, DuPont's Zonyl TM fluoromonomer H₂C═C(CH₃)CO₂CH₂CH₂(CF₂)ₙF n˜8, acrylonitrile, methacrylonitrile, calcium, sodium, aluminum, silver and zirconium acrylate and methacrylate, diallyldimethylammonium chloride, vinylidine chloride, vinylidine fluoride, vinyl chloride, vinyl fluoride, itaconic acid, itaconic anhydride, cinnamic acid, cinnamoyl chloride, cinnamonitrile, esters of cinnamic acid and itaconic acid.

Furthermore, combinations of two or more reactive species can be used. For example, two or more different alkenes, alkynes, or monomers might be combined. Other molecules might be added to mixtures of reactive compounds that could function as chain transfer agents in polymerizations or surfactants to keep certain species solvated. Any type of reactive molecule or combinations of reactive molecules should be considered. Any molecule that can react with the fracture surface including gases, liquids, or even a suspended or partially dissolved solid can be used.

In addition, compounds with two different functional groups, each of which is capable of forming a covalent bond with the surface, can be used. Specific examples include: 4-(chloromethyl)benzoylchloride, 4-(chloromethyl)benzoic acid, 3-(chloromethyl)benzoylchloride, and 4-vinylbenzyl chloride. It is unlikely that both functional groups in these molecules will always be able to react with the surface. Thus scribing in the presence of these reagents should produce functionalized surfaces.

The reactive species can be used neat, or can be diluted in inert solvents. It would be advantageous to dilute compounds, which must be synthesized because of lack of commercial availability, or that are expensive, rather than to employ neat liquids in silicon modification by scribing. Alkanes, e.g., octane and dodecane, can function as inert solvents because it is known that propane and methane do not react with ion-roughened silicon at low temperature. Perfluorooctane was also studied as a possible inert solvent. Hydrophobic corrals (0.5×0.5 cm²) prepared by scribing silicon that was wet with octane, dodecane, and perfluorooctane did not hold 20 μL water droplets. However, these lines did have low levels of hydrophobicity, which may be due to small amounts of unsaturated impurities or which may indicate a low level of reactivity between these compounds and scribed silicon.

The scribing can be done with a diamond scribe. Alternatively, a small tungsten carbide ball can be used to make lines on hydrogen-terminated silicon (not silicon with a thin oxide layer as before) that are crisp and sharp (as shown by AFM, SEM, and ToF-SIMS). They range in width from 15-35 μm (depending on the size of the ball and the pressure used). AFM shows that these new lines are only 5-20 Å deep. This technique can be used instead of microcontact printing for some applications.

It is surprising that the reactions reported herein took place in the air, under conditions where oxygen can diff-use through the thin layer of liquid that covered the surface, and might be expected to react with chemically active fracture surfaces. The implication is that the reactivity with scribed silicon shown by functional groups is high. Results of surfaces scribed in an oxygen-free environment with degassed alkenes showed only a small improvement in properties over those made in the air. Scanning electron microscopy of scribed lines made with a diamond scribe shows that they are 50-100 microns in width and that their interiors and edges are rough.

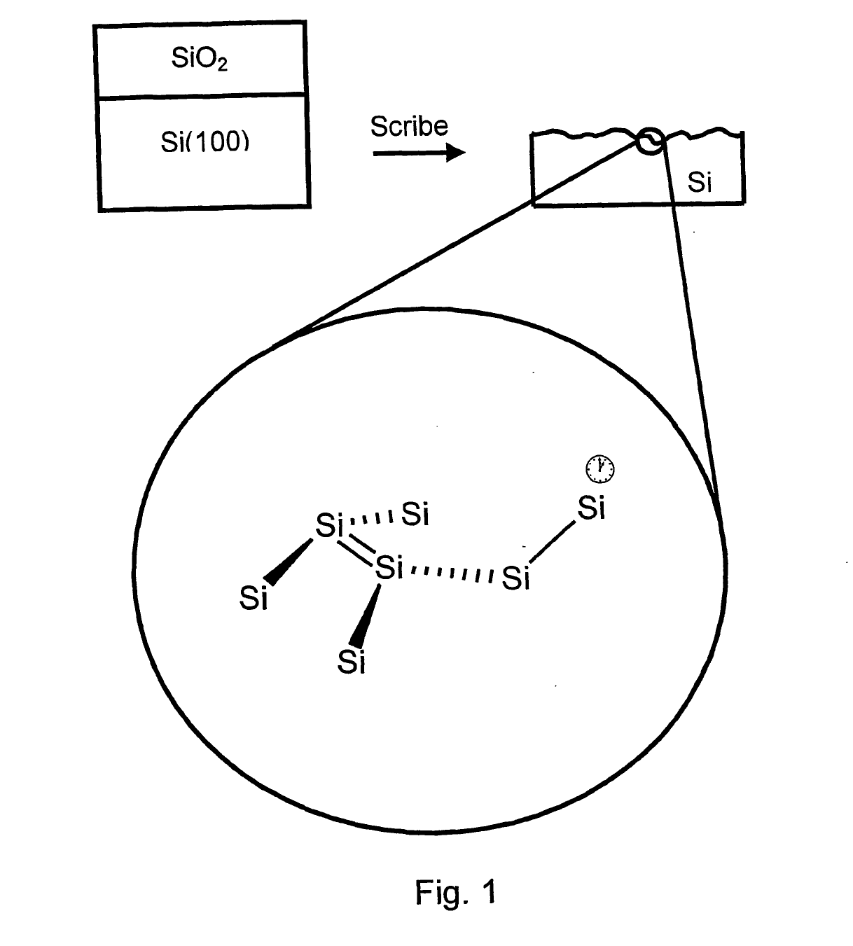

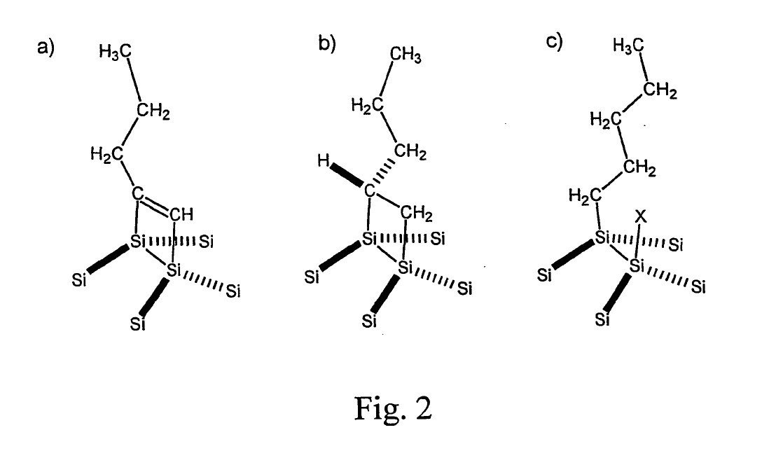

One example of how a material can be functionalized is the modification and patterning of silicon. This technique consists of (a) cleaning a silicon wafer to remove adventitious contaminants from its surface, leaving its thin native oxide layer (10-15 Å thick); (b) wetting the dry surface of the clean silicon with an unsaturated, organic molecule; (c) mechanically scribing the silicon with a diamond-tipped instrument while it is wet with the unsaturated, organic liquid, and (d) cleaning the scribed surface to remove excess organic liquid and silicon particles that are produced by scribing. Scribing silicon produces reactive species at fracture surfaces, as shown in FIG. 1. Monolayer quantities of alkyl chains are chemisorbed onto regions of silicon that are exposed by scratching when silicon is wet with a 1-alkene or a 1-alkyne, as shown in FIG. 2. Unlike other methods for forming monolayers on silicon that require inert atmospheres, high vacuum conditions, or special equipment, this technique can be performed under ambient conditions with minimal tools and supplies and without degassing or heating reagents. This method, performed with a diamond scribe, is a wet-chemical preparation of monolayers on silicon that does not require a hydrogen-terminated silicon intermediate.

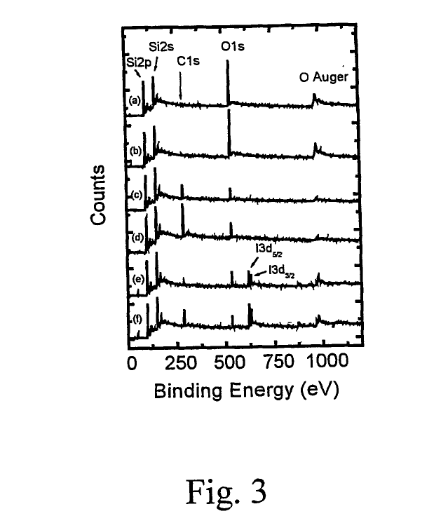

The process of functionalizing a surface by scribing it in the presence of a reactive species could be followed by X-ray photoelectron spectroscopy (XPS). FIG. 3 shows XPS survey spectra of (a) silicon that was scribed in the air, (b) silicon that was scribed in the air and then exposed to 1-dodecene, (c) silicon that was scribed in the presence of 1-pentene, (d) silicon that was scribed in the presence of 1-dodecene, (e) silicon that was scribed in the presence of iodomethane, and (f) silicon that was scribed in the presence of 1-iodooctane. When silicon is scribed in air (a), or in air and then exposed to an alkene (b), almost no carbon is found on the surface and a strong oxygen signal is observed. An identical spectrum to 3a is obtained when silicon is scribed in air and then exposed to 1-iodooctane. FIG. 3 shows that when scribing is performed in the presence of an alkene or an iodoalkane, less oxygen is present than when the surface is scribed in air and a carbon signal is observed that scales with the alkyl chain length of the hydrocarbon. In the case of the iodoalkanes, iodine is present at the surface.

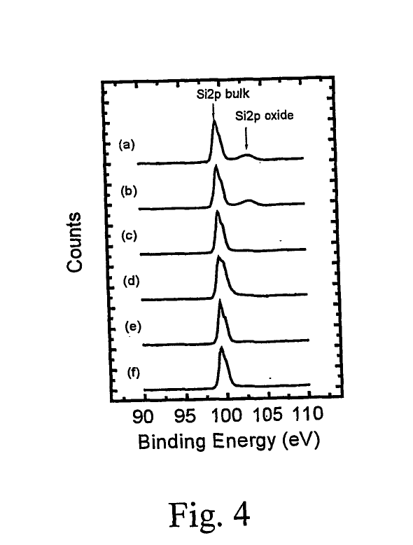

FIG. 4 shows the corresponding Si 2p narrow scans for the spectra shown in FIG. 3. Note that in (a) and (b) a significant amount of oxide is present on the surfaces but that in (c)-(f) that amount is greatly reduced.

This method provides considerable flexibility in patterning silicon. For example, enclosures of scribed lines, or squares that are drawn on the silicon surface, referred to herein as “hydrophobic corrals,” hold droplets of water and other liquids. The corrals can be used to contain droplets of water or other solvents in which chemical reactions can be run. Moreover, the bare silicon oxide in the interior regions of hydrophobic corrals can be functionalized, e.g., with polyelectrolyte multilayers. This method can thus be used to partition and selectively derivatize silicon and silicon surfaces with a wide variety of reagents and methods-that are known in the art.

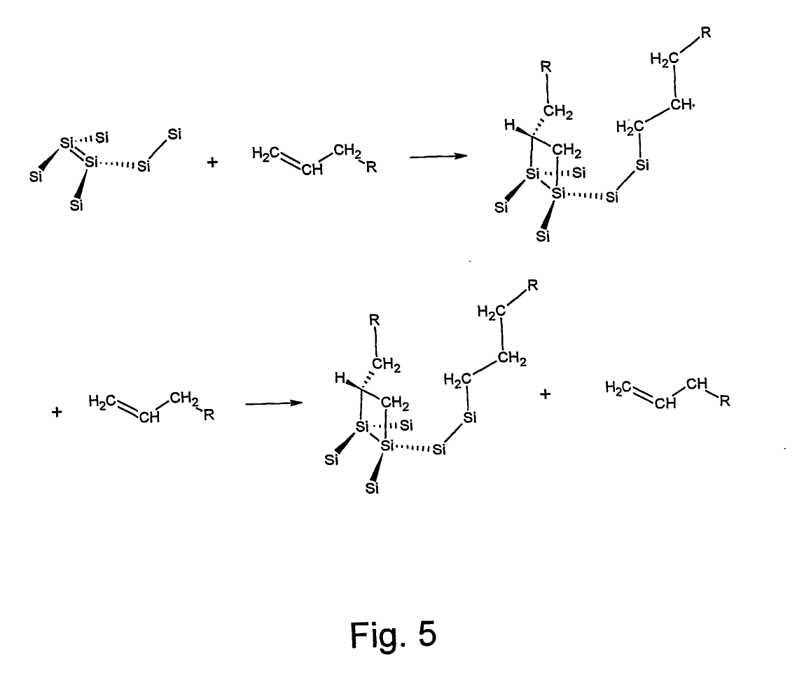

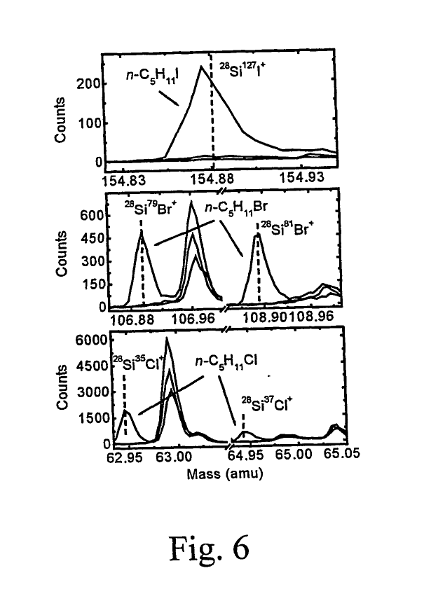

It is hypothesized that the mechanism of formation of these new monolayers on silicon is closely related to the reaction of alkenes and alkynes with highly active surface species on unpassivated, bare silicon, as shown in FIG. 5. For example, the Si(111) (7×7) surface reacts with acetylene, ethylene, and propylene to form two silicon-carbon bonds. Unpassivated Si(100) similarly reacts with acetylene, ethylene, propylene and other alkenes to form two silicon-carbon bonds. Neither methane nor propane reacts with annealed or ion roughened, unpassivated Si(100) at 120 K, while propylene readily reacts under these conditions.

X-ray photoelectron spectroscopy (XPS) and wetting data show that when silicon is first scribed in the air and then wet with a reactive compound no reaction takes place. However, when silicon is wet with a reactive compound and then scribed, monolayer quantities of alkyl chains are deposited. Time-of-flight secondary ion mass spectrometry (TOF-SIMS) shows numerous fragments that contain C and H as well as many fragments with Si, C, and H. These latter species suggest covalent attachment of alkyl chains to surfaces.

Monolayers, partial monolayers, or thicker films on reactive materials can be made by scribing in the presence of a number of reactive molecules with one or more different reactive functional groups. These molecules could have any of a variety of inert substituents such as alkyl chains or substituents that are less active than certain more reactive functional groups in the molecule. The reactive functional groups could be at any chemically reasonable position in a molecule. For example, a double or triple carbon-carbon bond could be positioned at the end of an alkyl chain or somewhere in its middle, i.e., CH₂═CH(CH₂)ₙCH₃ or CH₃(CH₂)ₙCH═CH(CH₂)ₘCH₃ (cis- or trans-) and HC≡C(CH₂)ₙCH₃ or CH₃(CH₂)ₙC≡C(CH₂)ₘCH₃, where n and m can be any reasonable integer values. Likewise, a C—X (X═Cl, Br, or I) or C—OH could appear at the end of an alkyl chain or along it, i.e., X(CH₂)ₙCH₃ or CH₃(CH₂)ₙCHX(CH₂)ₘCH₃, where n and m can be any reasonable integer values (in the approximate range of 0-20). Reactive molecules include those already mentioned, i.e., carbon-carbon double bonds (isolated and conjugated), carbon-carbon triple bonds, C—Cl bonds, C—Br bonds, C—I bonds, —OH groups, —COOH groups, Si—OH groups, N—H groups, oximes, amines, and thiols. Other groups such as aldehydes, ketones, and nitriles that may react with active surfaces can also be used. Carbon-carbon double bonds in monomers (and mixtures of monomers to make copolymers or simply surfaces with more than one attached group) can be employed. Examples of such reactive monomers include the acrylates (CH₂═CH—C(O)O—R), methacrylates (CH₂═CCH₃—C(O)O-R), derivatives of styrene (CH₂═CH—C₆H₄R, CH₂═CH—C₆H₃R₂, etc.), vinyl ethers (CH₂═CH—OR), maleic acid, maleic anhydride, esters of maleic acid (ROC(O)CH═CHC(O)OR), and cinnamic acid and its esters. Some of these monomers might polymerize from a scribed surface. All reactions with the surface could be performed in the air or in an inert atmosphere depending on the reactive molecule. A number of organic solvents, both aromatic and aliphatic (straight and branched), can be employed along with some ionic liquids or inorganic solvents. Branched alkanes would not be expected to intercalate into surface monolayers so that arrays of higher density might be formed than with straight-chain compounds. Epoxides (compounds with oxirane moieties) may also react with certain scribed surfaces.

### Functionalization Using Alkyl Halides

Monolayers on Si can be produced and Si surfaces concomitantly patterned by scribing Si that is wet with 1-chloro-, 1-bromo-, and 1-iodoalkanes. As with alkenes this process takes place under ambient conditions, without the need to degas reagents. A dry Si surface with its thin (10-20 Å) native oxide layer is simply wet with an alkyl halide and the surface is scribed. It is believed that surface species on scribed silicon, which may include Si═Si (double) bonds and Si dangling bonds (Si*), as are present on Si(100)-(2×1) and Si(111)-(7×7), respectively, react with alkyl halides to produce Si—X (X is Cl, Br, or I) and Si-alkyl species. This process is shown below for Si*: homolytic scission of a C—X bond is followed by condensation of Si* with an alkyl radical.

Si*+XCH₂(CH₂)ₙ₋₁H→SiX+*CH₂(CH₂)ₙ₋₁H (1)

Si*+*CH₂(CH₂)ₙ₋₁H→SiCH₂(CH₂)ₙ₋₁H (2)

While *CH₂(CH₂)ₙ₋₁H could diffuse away from the surface, it is likely that it will return to it by a random walk. Bond strength tabulations support this mechanism—the CH₃—X and C—X bonds are weaker than the Si—X bond. Step (2) is clearly energetically favorable. Once again, this method is a direct, wet-chemical preparation of monolayers on Si that does not require a hydrogen-terminated silicon intermediate.

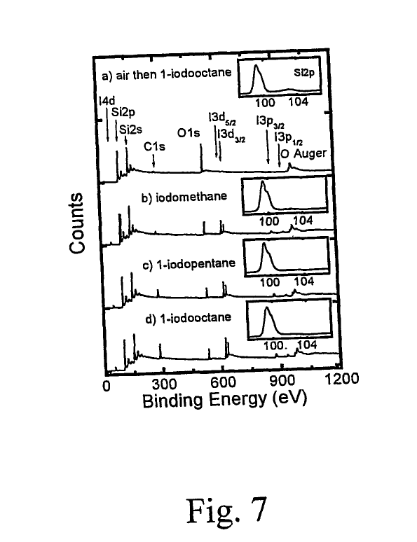

FIG. 7 shows X-ray photoelectron (XP) spectra of Si surfaces that were (a) scribed in the air and then wet with I(CH₂)₇CH₃, and (b-d) wet with three different alkyl iodides and then scribed. Prior to scribing, the clean Si was completely hydrophilic. After scribing, the control surface (a) was bydrophilic, but the others were hydrophobic. The C1s peaks in FIG. 7 (b-d) show monolayer quantities of alkyl chains, and the peak areas are proportional to the number of carbons in the alkyl halide. Surfaces scribed under iodoalkanes have smaller O 1s peaks than the control surface (a), and significant I signals. The narrow scans of the Si 2p region (FIG. 7b-7d insets) show less oxide at ˜103 eV than the control (FIG. 7a). Because the Si—X bond is easily hydrolyzed in most molecular compounds, it might be considered surprising that I is present on surfaces that had been rinsed with water as part of the cleaning procedure. However, Cl-terminated Si(111) has been found to hydrolyze slowly in the air or even when immersed in water.

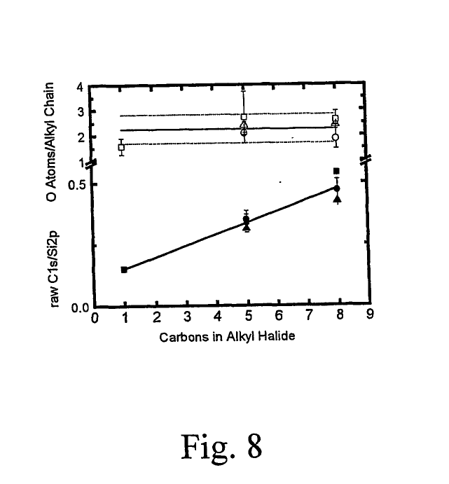

The XP spectra of Si scribed under 1-brornoalkanes and 1-chloroalkanes also had significant halogen signals, little oxidized Si, and C1s signals similar to those in FIG. 7. The linear fit of the ratio of C1s to Si2p peak areas for all of the 1-haloalkane data is: C1s/Si2p=0.047×(Carbons in Alkyl Halide)+0.10, and the ratio of O atoms per alkyl chain is roughly constant (2.26±0.56), and essentially equal to the value reported for 1-alkenes and 1-alkynes, as shown in FIG. 8. Solid symbols show the ratios of areas of C1s to Si2p peaks, and open symbols show ratios of O atoms per alkyl chain. Squares, circles, and triangles correspond to alkyl iodides, alkyl bromides, and alkyl chlorides, respectively.

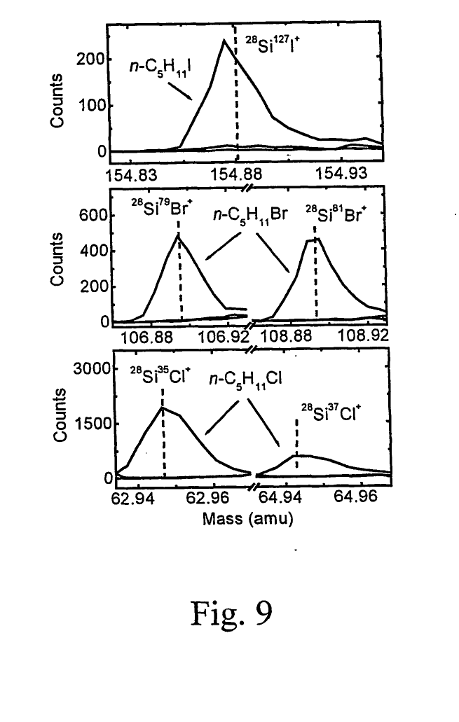

Evidence for the formation of surface Si—X species was provided by static time-of-flight secondary ion mass spectrometry (ToF-SIMS). FIG. 9 shows positive ion spectra of Si surfaces scribed under 1-halopentanes (1-halooctanes gave the same result), where dashed vertical lines show theoretical masses of ²⁸SiX⁺ cations. The top panel shows that Si¹²⁷I⁺ is only present in the spectrum of the I(CH₂)₄CH₃-derived surface, and not in the spectra of the Br— and Cl—(CH₂)₄CH₃-derived surfaces. The middle and bottom panels show that Si⁷⁹Br⁺ and Si⁸¹Br⁺ are only in the Br(CH₂)₄CH₃-derived surface spectrum, and that Si³⁵Cl⁺ and Si37Cl+ are only in the spectrum from the Cl(CH₂)₄CH₃-derived surface. The Br— and Cl— containing peaks in FIG. 9 correlate well with the natural isotopic abundances of ⁷⁹Br (51%) and ⁸¹Br (49%), and ³⁵Cl(76%) and ³⁷Cl (24%). Peaks from CHₙX⁺ (n=0-3), and C₂HₙX⁺ (n=0-5) were not observed. These data support the hypothesis that halogen atoms covalently bind to Si when Si is scribed under alkyl halides.

A particular strength of this scribing technique is that silicon functionalization takes place under ambient conditions and without the need to degas scribing liquids. However, silicon oxidizes readily and so it is reasonable to expect that dissolved oxygen would compete with the scribing liquid for surface sites, as proposed above for silicon scribed under 1-alkenes and 1-alkynes. Thus, to better understand the role of oxygen in monolayer formation on scribed silicon, silicon was scribed under 1-chlorooctane, 1-bromooctane, 1-iodooctane, 1-octene, and 1-octyne in the air, and in a glove box with degassed compounds.

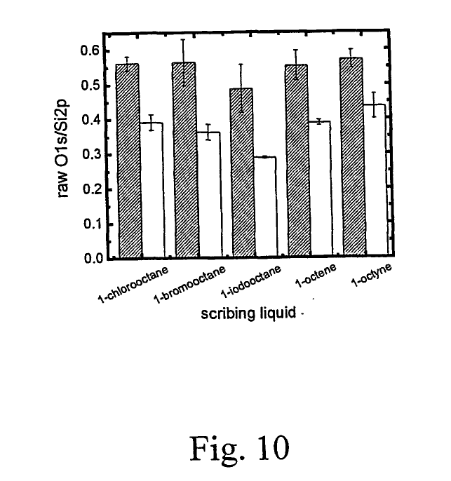

FIG. 10 shows the ratio of XPS peak areas of oxygen (O1s) to silicon (Si2p) for the resulting surfaces. It is clear for all of these compounds that more oxygen is present when silicon is scribed in the air than in an inert atmosphere. In this same set of experiments the C1s/Si2p ratio was generally somewhat higher for silicon scribed in the glove box than in the air, the amounts of chlorine (from 1-chlorooctane) were roughly the same under oxygen-free conditions and the air, and the amount of Br and I was greater for silicon scribed in a glove box. The lower oxygen levels and the higher bromine and iodine signals of silicon scribed in the air under 1-bromo- and 1-iodooctane can be attributed to the weakness of the C—Br and C—I bonds.

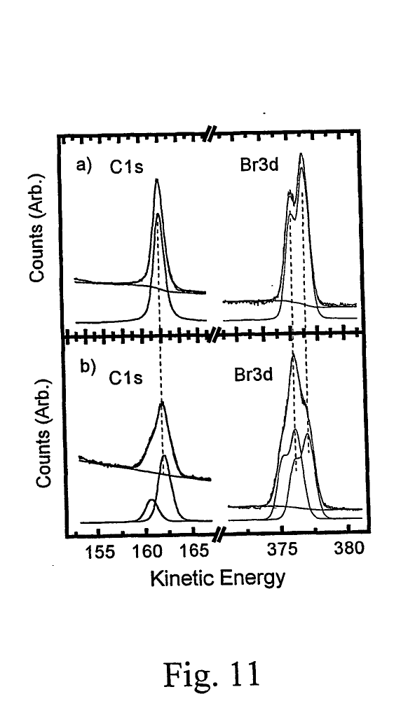

To create functionalized surfaces that themselves can be further elaborated, the surfaces can be scribed in the presence of bifunctional or polyfunctional compounds. In an attempt to create a useful leaving group on the surface, silicon was scribed under Br(CH₂)4Br. FIG. 11 shows XP spectra taken on Beamline 8-2 at the Stanford Synchrotron Radiation Laboratory and fits to the data for Si scribed under a) Br(CH₂)₄CH₃ and b) Br(CH₂)₄Br. The lower C1s spectrum (unlike the upper) has two components. The smaller peak in b), which is 26% of the fit area, can be attributed to C—Br species, and the larger to the remaining C atoms. The Br3d signals in FIG. 11 from Br(CH₂)₄CH₃-derived surfaces are fit to a single doublet, but those from the Br(CH₂)₄Br-derived surface are well fit with a pair of doublets, indicating two chemical states for Br, i.e., Si—Br and C—Br. These results suggest that functionalized monolayers consisting of Si—(CH₂)ₙX and Si—X moieties, where both X's could act as leaving groups, can be prepared by scribing Si under dihaloalkanes.

In addition to the patches of scribed silicon that were studied above by XPS and ToF-SIMS, silicon was patterned with checkerboard arrays of hydrophobic lines (0.5 cm apart), as described above with 1-alkenes and 1-alkynes. As before, the resulting square enclosures, or hydrophobic corrals, were probed with 20-microliter test droplets of methanol-water mixtures with different surface tensions, and corrals made from alkyl halides with longer chain lengths held test droplets with lower surface tensions. The following list gives the scribing liquid followed by the lowest surface tension of a test droplet (held) and the highest surface tension (not held) by corrals: Cl(CH₂)₄CH₃ (40.5±3.3, 37.5±3.7), Br(CH₂)₄CH₃(38.5±3.9, 35.8±4.2), I(CH₂)₄CH₃ (42.5±4.6, 39.2±4.8), Cl(CH₂)₇CH₃(34.9±0.0, 32.0±0.0), Br(CH₂)₇CH₃(36.8±2.7, 33.7±2.6), I(CH₂)₇CH₃ (32.7±1.3, 30.2±1.1).

### Formation of Hydrophobic Corrals

As described above, hydrophobic corrals can be formed on a surface, such as a silicon surface, by scribing the surface in the presence of an alkene, alkyne, or alkyl halide. For example, a grid of lines spaced apart by 0.5 cm can be scribed in the surface, producing a grid of hydrophobic barriers. Hydrophobic corrals can also be made by scribing in the presence of carboxylic acids. However, the hydrophobicity is lost after the sample has been rinsed with water for a few minutes, a result consistent with a Si—OC(O)R linkage that is susceptible to hydrolysis.

The preparation of arrays of hydrophobic corrals is surprisingly straightforward and has been automated. Each distinct drop of liquid in a hydrophobic corral can function as an autonomous reaction vessel so that chemistry can be performed within the drop or so that the interior surface of the corral may be modified. Each hydrophobic corral has two key components: hydrophobic lines or boundaries and an interior region.

In order to quantify the hydrophobicity of the corrals, 0.5×0.5 cm square hydrophobic corrals were probed with a series of 20-microliter droplets of methanol-water mixtures that had surface tensions that decreased progressively in steps of 2-3 dynes/cm from 72.8 dynes/cm (water) to 21.9 dynes/cm (methanol). The lowest surface tension of a drop that could be held by the corral and the highest surface tension of a drop that overran the hydrophobic lines of the corral were recorded. In order to produce test corrals that were as uniform as possible and to demonstrate that the scribing process could be automated, silicon surfaces were covered with a reactive liquid and then scribed on a computer controlled milling machine (CNC) that used a specially designed spring-loaded diamond tip and a custom-built holder for the silicon.

Table 1 presents the passing and failing surface tensions for 20-microliter methanol-water drops in 0.5×0.5 cm square hydrophobic corrals on silicon, where the scribing was performed using the CNC with the indicated liquids. Air, water, n-octane, n-dodecane, and perfluorooctane do not react with the surface to form hydrophobic corrals, which is consistent with earlier high vacuum studies of unpassivated silicon. While alkanes and perfluoroalkanes do not appear to react, hydrophobic corrals can be made by scribing in the presence of alkenes, alkynes, alcohols, reactive monomers, and alkyl halides. As expected, the passing methanol-water surface tension of a corral decreases with increasing alkyl chain length for each class of reactive molecule and the passing surface tension increases as the compounds are diluted in an inert solvent. The most hydrophobic corral in Table 1 is produced from a fluorinated alkene (CH₂═CH(CF₂)₅CF₃), consistent with the fact that the —CF₂— and —CF₃ groups have some of the lowest surface tensions known. It is also important to stress that the corral interior surface remains hydrophilic (unfunctionalized) after scribing, rinsing with solvents, and drying in a jet of nitrogen. Therefore, it is possible to derivitize this region by any of a number of methods known in the art.

Table 1 also contains XPS data. The C1s/Si2s ratio is much lower for the controls than for silicon scribed in the presence of reactive molecules. Results for the alkenes, atynes, and alkyl iodides show that the C1s/Si2s ratio increases with increasing alkyl chain length. Scribing in both 10% styrene in dodecane and in dodecylacrylate yields significant levels of surface carbon.

As shown above, the hydrophobicity of the corrals can be increased by using perfluorinated species such as perfluorinated alkenes, alkynes, alcohols, alkyl halides, silanes, or monomers with perfluorinated side chains, such as DuPont's Zonyl TA—N and Zonyl TM monomers. An increase in line hydrophobicity should allow solvents with fairly low surface tensions to be used to modify or probe corral interiors.

### Functionalization of Corral Interiors

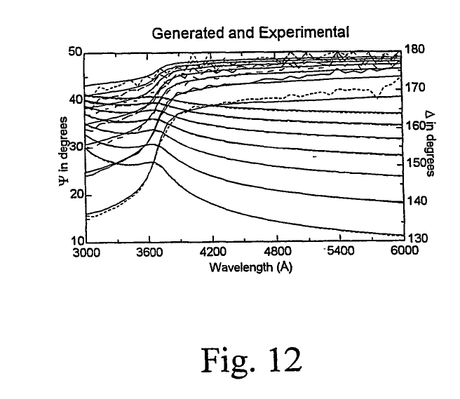

The hydrophobic corrals can be used simply as boundaries between reactions. Or, the interiors of the corrals can be selectively functionalized. To demonstrate that the interiors of hydrophobic corrals can be functionalized, ultrathin (<10 Å each) polyelectrolyte polymer layers were sequentially deposited from dilute aqueous solutions (1.33×10⁻³ M in the monomer). An electrostatic attraction between an adsorbed polymer layer and a polymer in solution drives film formation and an electrostatic repulsion between similar polymer chains then limits deposition to essentially monolayer quantities. To rinse the interior of the corral following each polymer deposition, ¾ of the liquid was removed and then replaced by water. This rinse procedure was repeated 5 times, lowering the concentration above the surface to less than 0.1% of the original value. Then ¾ of the liquid was again removed and replaced with the polymer solution, making the polymer concentration over the surface 10⁻³ M (monomer). In this new way of depositing polyelectrolyte multilayers only the hydrophobic corral was rinsed, never the entire surface. The increase in film thickness with polymer deposition was followed with variable angle spectroscopic ellipsometry (VASE). An initial sticking layer of polyethylenimine (PEI) was deposited inside the corral in the manner described here, followed by layers of polystyrene sulfonate (PSS), polyallylamine hydrochloride (PAH), PSS, and finally PAH again. The thicknesses by VASE were: PEI (2 Å), PEI/PSS/PAH (12 Å), and PEI/(PSS/PAH)₂ (19 Å) (each of these three test surfaces was different and the surface was always under water until all deposition steps were completed). FIG. 12 shows the excellent theoretical fits (solid lines) to the data from the PEI/(PSS/PAH)₂ film at a variety of angles of incidence (40° -70° in 5° increments) (Ψ and Δ represent the change in ratio of amplitudes and phases of p- and s-polarized light, respectively).

### Alternative Methods for Functionalizing Surfaces

Different methods of etching the surface can be used to create reactive species and a miniaturization of the feature size. For example, a CNC milling machine that reduces the distance between the lines in the standard checkerboard pattern can be used. Simply cutting the size in half (0.25 cm) will allow a surface to be created with 64 hydrophobic corrals in a 2 cm² region. As the dimensions of the corrals are reduced, the pressure put on the diamond tip can also be reduced to shrink the width of the hydrophobic lines. Other technologies such as electron beams, lasers, ion beams, or AFM tips could be used to increase the ease of scribing surfaces or obtaining a greater reduction in feature size. An example of some new translation stage technology that has less than 100 nm resolution is the Melles Griot nanopositioning stages. Heat could also be used to remove a passivating layer on a substrate so that it could then be exposed to a reactive molecule.

Scribing can also be done in the presence of bifunctional reactive species, such as monomers, that contain two or more polymerizable groups to leave the surface functionalized. Examples of such monomers include divinyl benzene, diacrylates, dimethacryates, and divinylethers.

Another alternative is to post-functionalize the scribed line. In other words, a functionalized line can be drawn (created) and then some chemistry can be performed on it, e.g., a transformation of one functional group into another.

The surface can be scribed before or after functionalization has taken place. For example, one could scribe a clean silicon surface with its 10-15 Å of native oxide in the presence of a reactive molecule, or one could functionalize this surface with, for example, a silane like 3-aminopropyltriethoxysilane and then scribe in the presence of a reactive molecule. Gas phase silanization could also be performed before or after scribing in the presence of a reactive species. It may be also possible to first scribe in the air or under inert conditions and then quickly expose to a reactive molecule, although it is preferable that this be done under inert conditions.

Yet another method of functionalization includes silanizing a piece of glass, or covering it with PEI; then scratching a few select areas with a silane present in a solution of an aprotic solvent, optionally with some water present. The silane reacts only where scratching takes place, and the glass is thus functionalized. If the glass is not protected, significantly more silanization can take place where scratching takes place than where it doesn't.

### Uses and Variations for Hydrophobic Corrals

The hydrophobic corrals can be modified, depending on the ultimate application for which the corrals are to be used. “Smart” boundaries can be prepared. For example, at a certain pH or oxidation potential or upon exposure to a certain chemical species or light, the boundary, e.g., a hydrophobic line, might lose its ability to hold back water or even become more hydrophobic. In addition, channels can be made along surfaces for water or other liquids to flow in.

### Other Uses for Functionalized Surfaces

Surfaces can be scored in the presence of a mixture of monomers to determine reactivity ratios in copolymerizations by characterizing the polymer brush that grows off the surface of the scored region. The tribological properties of surfaces (friction and wear) can be tested by dragging a stylus over selected regions until they fail or twisting a rod like a drill bit into the surfaces until failure occurs. In a slight variation, polymer layers can be deposited before scribing by means known in the art, and then partitioned into an array of hydrophobic corrals. The ability of different reagents to dissolve the polymers, functionalize the polymers, or the resistance of the polymers to harsh reagents can then be tested.

Catalytic surfaces or surfaces that have special recognition sites can be prepared, e.g., by polymerizing in the presence of a template molecule, where the monomers will form hydrogen bonds, van der Waals bonds, or other attractive forces, and then removing the template molecule from the polymer. The affinity of the resulting polymers for the analyte of interest can then be tested. The best set of monomers and their optimal concentrations for making the best possible recognition or catalytic surface can then be determined. If the template molecule is a transition state analog of a reaction, the surfaces would be expected to behave catalytically.

The methods of the invention can also be used to test the ability of certain coatings and thin films to resist harsh conditions such as acid, base, fluoride ion, and other caustic substances. They can also be used to study corrosion. This can be done by depositing a thin metal film on the surface; scratching to partition it into hydrophobic corrals; testing which reagents corrode the metal most easily; and finding ways to inhibit the corrosion.

The methods can also be used to study wetting properties of polymers and thin films. To do this, small droplets of different liquids are applied onto surfaces from narrow tubes, and the resulting contact angles are examined. They can also be used to test a wide variety of bioconjugate chemistries to find optimal conditions for coupling species to surfaces.

### Methods for Functionalizing the Interiors of Hydrophobic Corrals

Once formed, the hydrophobic corrals can be functionalized in a variety of ways. For example, gold can be electrochemically deposited in the enclosed regions; the surfaces can then be functionalized with thiols. Layers of polyelectrolyte polymers, i.e., polycations, polyanions, DNA, RNA, proteins, or viruses can also be used to functionalize the enclosed areas. When it is desirable to avoid protein adsorption, a combinatorial library of monolayers or polymers can be created to test which regions resist protein adsorption the best. In addition, polymer brushes can be grown in the enclosed regions by a number of methods known in the art. The compositions of a number of copolymers in hydrophobic corrals can then be studied in a combinatorial fashion, and their effectiveness as substrates for cell growth can be evaluated. Different regions of a surface can be functionalized with different compounds by scribing one area with one compound then another area with a different compound.

Alternatively, thin polymer or monomer layers can be grown in hydrophobic corrals on silicon, diamond, germanium, silicon, quartz, a different polymer (glassy) in a combinatorial fashion. One can then study the effects of different coatings in interior regions of hydrophobic corrals on crystal growth.

The functionalized interiors have a variety of uses. For example, hydrophobic corrals made by scribing glass, silicon, or quartz or another material in the presence of a reactive species could be used as a replacement for microtiter plates.

The patterned plates can be used in proteomics; patterned arrays of different proteins can be deposited onto the surfaces. This technology can be used in combinatorial chemistry to prepare arrays of compounds (libraries) that could then be screened for drug activity. Oligonucleotides could be immobilized in certain regions of the surface. Many of the biological assays that are currently done with microplates could be done as well or better using this technology.

Biologically relevant species can be attached, and basic bioconjugation techniques can be applied to the interior of hydrophobic corrals. Hydrophobic corral interiors can be functionalized with amine- and thiol-terminated silanes (both before and after scribing to make hydrophobic lines). Groups that are extensively used in bioconjugation such as NHS-esters, maleimides, and α-haloacetamides will react with one or both of these groups. Biotin can be attached to amine-terminated surfaces using both EDC, a commonly used coupling agent, and photobiotin. The affinity of the surface for avidin and streptavidin could then be determined. Single stranded DNA can also be bonded to the surface; hybridization with its complementary strand can then occur.

Alternatively, electrochemistry can be performed in certain enclosed regions. The best conditions for metal deposition can be found, and the effects of different additives on the process can be studied. Multilayers can be made with metal phosphonates, and polyelectrolyte multilayers can be deposited. Charged proteins, charged viruses, charged colloids can be deposited through electrostatic interactions.

Combinatorial libraries on surfaces can be created with an array of hydrophobic corrals. They can then be tested for activity as drugs, or as other useful molecules.

A range of organic reactions can be performed in a solvent drop in an enclosure on a surface. In this case the surface performs no function except to be a barrier so that the solvent cannot escape. The solvent can then be freeze-dried or evaporated, leaving behind the products that can be probed by mass spectrometry, e.g., SIMS. Or if the solvent is not removed, the solution above each region can be analyzed by chromatography. For example, LC or LC/MS can be done from liquid above the drop on a surface. “Aliquot exchange” can be used to exchange liquid between hydrophobic corrals or other reservoirs of liquid. This method can be used to rinse functionalized areas without having to dry them.

Cell growth can be studied on these surfaces. A wide variety of materials in different regions of a surface can be made and their affinities for different cells tested.

MALDI can be performed using functionalized surfaces. Hydrophobic corrals can be formed on a silicon surface. A reaction can be done in the corral, or the corral can be used to hold liquid with an analyte of interest in it. A reagent, e.g., an appropriate organic acid, which will absorb laser light at an appropriate frequency is added so that laser desorption can occur.

Hydrophobic corrals can also be used to screen cell lines to see which surfaces inhibit and which promote cell growth. They can also be used to find materials that inhibit and that promote enzyme adsorption.

The functionalized surfaces can be used to find better inorganic catalysts. Reactions (often inorganic) can be performed in hydrophobic corrals, the solvent removed, and the materials sintered or calcined as necessary.

The surfaces can be studies using a variety of techniques, including PS, TOF-SIMS, MALDI, tribological measurements, wetting measurements, and microscopy (SEM, optical).

Another way to use functionalized surfaces is to make hydrophobic corrals, then to make porous silicon in their interior regions. Porous silicon provides a large surface area that would be valuable in many applications. For example, if porous silicon is functionalized it could be used as a sensor, absorbing some moiety out of a solution or from the air. Porous silicon could be functionalized with virtually any useful functional group such as carboxyls, amines, or sulfhydryls, or even biologically relevant species such as antibodies. If it is left unfunctionalized, the bare oxide could pull polar species out of a solution. Biotin-functionalized porous silicon could bind avidin or streptavidin-labeled proteins.

### Micromachining

Micromachined devices can be coated to do chromatography and electrophoresis using the methods described herein. Methods of activating surfaces such as silicon/silicon oxide include energetic electron beams.

To micromachine, the surface of a substrate is protected with a polymer, e.g., by spin coating a polymer onto it or silanizing it. Lines are scratched in a few select areas; it may or may not be necessary to etch the surface to smooth the lines. This can be done with glass, quartz, silicon, germanium, diamond, or other materials. Two such scribed surfaces can be brought together such that their lines overlap. Capillary electrophoresis, capillary electrochromatography, or chromatography can be done in the resulting channels. To fill the columns with particles for capillary electrochromatography, emulsion polymerization can be done in situ.

A novel variation of covalent surface modification by scribing in the presence of reactive compounds, which can be carried out in the gas phase and is compatible with conventional silicon micromachining, is described below. In a chamber with a vacuum maintained in the range of 10⁻⁵-10⁻⁶ torr, relatively inert gases such as Ar can be stripped of one or more electrons, and an applied electrical potential can accelerate the resulting ions toward a surface. Collisions between the accelerated ions and the surface lead to ablation of surface atoms (1), with milling rates in the range of a 1 micron thickness of surface material per hour. For a Si substrate, the ablation of surface atoms in the vacuum chamber in the absence of reactive molecules such as O₂ or H₂O, should create highly reactive, dangling Si bonds (once the native oxide layer is first removed) in a manner analogous to scribed Si. These dangling bonds can then be covalently derivatized by backfilling the vacuum chamber with volatile alkenes, alkynes, etc. that will react with the Si surface to create a chemically modified substrate.

This novel approach has several key advantages. First, the process utilizes equipment that has already been developed for conventional Si surface micromachining, and is thus compatible with those processes. Second, the ability to functionalize samples in the gas phase is amenable to batch processing for high-throughput generation of samples. Moreover, this procedure should enable the use of conventional photolithography and masking to selectively pattern surface features with these reactive layers, which should facilitate construction of hydrophobic corrals for surface experiments with lipids, cells, or other biological specimens. The use of highly focused ion beams to effectuate ion beam milling with nanometer resolution (2) could also be used in conjunction with this approach to create chemically distinct, functionalized regions of nanometer dimensions on surfaces.

One useful application of this methodology is in the fabrication of micromachined chromatography columns in Si substrates.

Chromatography columns can be created as follows: (a) Channels are etched into Si using conventional micromachining. (b) Ion milling removes the native oxide layer in the etched grooves and activates the surface Si atoms. (c) Filling the vacuum chamber with alkenes, alkynes, etc. creates a chemically modified monolayer in the channels. (d) Bonding of two substrates generates chromatography columns.

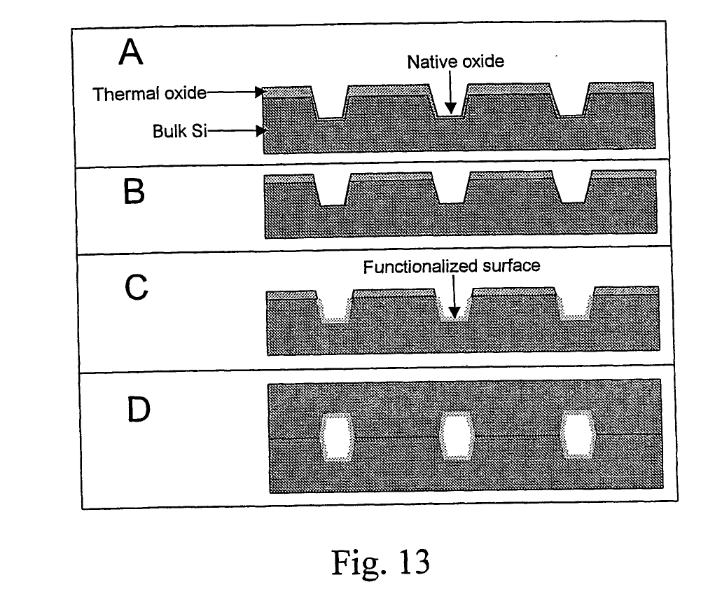

Conventional processing of a Si wafer allows creation of grooves in the surface (FIG. 13a) with a thermally grown oxide film as an etch mask; this surface could then be ion milled to remove the native oxide layer on the channel regions and create reactive Si bonds (FIG. 13b); then backfilling with a volatile alkene alkyne, etc. will chemically derivatize the surface (FIG. 13c). The functionalized surfaces can then be bonded together to create micromachined chromatography columns (FIG. 13d).

### EXAMPLES

The following examples are meant to be illustrative, and are not meant to be limiting in any way.

Materials. The following chemicals were obtained from Aldrich and used as received: 1-pentene (99%), 1-octene (98%), 1-dodecene (95%), 1-hexadecene (92%), CH₂═CH(CF₂)₅CF₃(99%), 1-pentyne (99%), 1-octyne (97%), 1-dodecyne (98%), (99+%), dodecane (99+%), CF₃(CF₂)₆CF₃(98%), ¹³CH₃I (99 atom % ¹³C), 1-chlorodecane (98%), 1-bromododecane (97%), and 1-iodododecane (98%), polyethylenimine (50 wt. % soln., M_{w}˜750,000), poly(sodium 4-styrene sulfonate) (M_{w}˜70,000), poly(allylamine hydrochloride) (M_{w}˜70,000). CH₃I was obtained from Fisher (99.8%) and was used as received. Acetone and m-xylene were reagent grade and water was obtained from a Millipore Milli-Q Water System. Glycerol (Certified A.C.S., Fisher Scientific), ethylene glycol (Analytical Reagent, Mallinckrodt), and sodium dodecyl sulfate (NF Grade, Columbus Chemical Industries) were used as received. Silicon (100) wafers (p-boron, 0-100 Ω-cm, test grade) were obtained from TTI Silicon (Sunnyvale, Calif.).

Silicon Cleaning. Silicon surfaces were cleaned by immersion in ˜50:50 (v/v) H₂O₂ (300%): NH₄OH (conc.) for 30-45 minutes at room temperature and then rinsed with copious amounts of water. (Note: Mixtures of concentrated H₂O₂ and NH₄OH are exceedingly caustic and should be handled with great care.) After cleaning and drying with a jet of N₂, the silicon surfaces were completely hydrophilic. H₂O₂/NH₄OH cleaning solutions were carefully neutralized with a concentrated solution of citric acid before disposal.

Sample Preparation. Unless otherwise specified, all sample preparations were done in the air with compounds that had not been degassed. To obtain surfaces for YPS and TOF-SIMS analyses, silicon surfaces were cleaned and rinsed as described above, dried with a jet of nitrogen, wet with an organic liquid, and scribed (by hand) with a broad, diamond-tipped machining tool over a region large enough (˜1 cm²) to easily accommodate XPS and TOF-SIMS probe beams. For a few of the surfaces, this process was automated by using a spring-loaded diamond-tipped rod that was held and moved by three orthogonally-mounted computer-controlled translation stages (Coherent). After wetting the surface with a reactive compound, lines were drawn 50 μm apart in one direction to cover a region of interest and this same rastering was then performed perpendicular to the original direction. The diamond-tipped rod was obtained from a diamond scriber sold by VWR (Cat. No. 52865-005). (After repeated use, diamond tips begin to degrade and may produce double lines on silicon.) Three Labmotion™ Series 640 Linear SmartStages™ (catalog number 61-7225) were connected to a controller chassis with LabMotion™ Stepper Drive Modules SDM-1, which was in turn controlled through the LabMotion™ Designer Software.

In some experiments, hydrophobic corrals were made by scribing silicon, which had been wet with a reactive liquid, with a spring-loaded diamond tip in a custom-designed holder that was attached to and moved by a computer numerically controlled (CNC) Fryer MB15 bed mill. A program instructed the machine to make 5 horizontal and 5 vertical lines 0.5 cm apart, i.e., 16 corrals.

After scribing, samples were rinsed with copious amounts of acetone followed by water, were cleaned by rubbing with a soft artist's brush and a 2% sodium dodecyl sulfate solution, and were finally rinsed again with copious amounts of water. In a few cases, surfaces were gently rubbed with a gloved hand instead of a brush during the cleaning process. After cleaning, surfaces were dried with a jet of nitrogen. After exposure to the laboratory environment for many days, hydrophilic regions on silicon surfaces became hydrophobic. Further details on sample preparation are described in Niederhauser et al., Langmuir 2001, 17, 5999-5900.

For interior region functionalization, hydrophobic corrals were made fairly large (1.5×1.5 cm²) to accommodate the footprint of an ellipsometer light beam. These hydrophobic corrals were produced by scribing silicon in the presence of 1-hexadecene and were found to easily hold 400 μL droplets of water, which volume was used in surface functionalizations with polyelectrolytes. In the first step of the derivitization, 400 μL of water was added to a hydrophobic corral with a micropipettor. Next, 300 μL of a 400 μL water droplet was removed with a micropipettor and replaced with 300 μL of an aqueous solution of a polyelectrolyte (1.33 mM in monomer) making the solution above the surface 1 mM (in monomer).

After allowing 30 minutes for the adsorption of the initial layer of polyethylenimine (PEI) and 20 minutes for subsequent layers of poly(sodium 4-styrenesulfonate) (PSS) or poly(allyl amine) hydrochloride (PAH), 300 μL of the 400 μL 1 mM polyelectrolyte solution was removed and replaced with 300 μL of water. This rinse was repeated 5 times, lowering the concentration above the surface to less than 0.1% of its original value, where complete mixing was assumed. Next, 300 μL of the drop was removed and replaced with the next 1.33 mM polymer solution. With each addition, liquid was repeatedly sucked up into the tip of the micropipettor and reinjected into the droplet over the hydrophobic corral to mix the liquids. In this manner, the region inside the hydrophobic corral was altered without affecting the surrounding surface.

Instrumentation. X-ray photoelectron spectroscopy (XPS) (VG Eclipse 220i-XL) was performed with a monochromatic Al K_{α} X-ray source and with an electron take-off angle of 90°. In analyses of XPS data, which were performed with the instrument software, it was assumed that all of the carbon on the surface comes from the unsaturated species and no attempt was made to account for attenuation of photoelectrons.

X-ray Photoelectron Spectroscopy (XPS) of 1-chlorodecane, 1-bromododecane, and 1-iodododecane-modified silicon was performed with an SSX-100 X-ray photoelectron spectrometer with a monochromatic Al k_{α} source and a hemispherical analyzer. The analytical chamber was pumped with a CRYO-TORR 8 cryopump (CTI-CRYOGENICS) giving a typical base pressure during data acquisition of<3×10⁻⁹ Torr. Data acquisition and processing were performed with the latest version of the instrument software (ESCA NT 3.0).

Static time-of-flight secondary ion mass spectrometry (TOF-SIMS) (Cameca/ION-TOF TOF-SIMS IV) was performed with a monoisotopic 25 keV ⁶⁹Ga⁺ primary ion source in “bunched mode” to achieve a mass resolution of ˜10,000 (m/Δm). The primary ion (target) current was typically 3 pA, with a pulse width of 20 ns before bunching, and the raster area of the beam was 500×500 μm². To obtain the data shown here, peak intensities (maxima) at appropriate masses were divided by the peak intensity of the ²⁸Si⁺ peak, which was consistently one of the largest features in the spectra.

Variable angle spectroscopic ellipsometry N44, J.A. Woollam Co.) was performed at 44 wavelengths between 286.1 and 605.2 nm, inclusive. Optical constants in instrument software files (SIO2.MAT and si_jaw.mat), which had been obtained from the literature, were used to model silicon oxide and silicon. The thicknesses of the single PEI layers reported herein were obtained with an M-2000 variable angle spectroscopic ellipsometer (J.A. Woollam Co.), which takes 498 data points from 190.51 nm to 989.43 nm, inclusive. Models were created and data analyzed with the instrument software. The mean squared errors (MSE) of all fits of models to experimental data were less than 5, which is generally considered to be an excellent fit.

Scanning electron microscopy (SEM) was performed with a JEOL JSM 840A instrument. Profilometry was performed with an Alpha-Step 200 profilometer. The stylus can be modeled as a 60° cone rounded to a spherical tip with a 12.5 μm radius.

Atomic force microscopy (AFM) was carried out using a Digital Instruments (Santa Barbara, Calif.) Multimode Nanoscope IIIa instrument operating in contact mode with etched Si tips and an imaging setpoint of 2.0 V. Height images were modified with a zero order flatten and 1^{st} order planefit to account for the difference between the plane of the sample and that of the piezoelectric scanner. Image analysis was performed offline using the roughness and section commands provided in the AFM software.

Methanol-Water Mixtures for Probing Hydrophobic Corral Wetting Properties. A series of methanol-water mixtures with different surface tensions was used as a means of comparing the hydrophobicity of functionalized lines that make up hydrophobic corrals.

The wetting properties of hydrophobic corrals were probed by placing 20 μL of a methanol-water test mixture into a hydrophobic corral using a 25 μL syringe (Hamilton Co., Reno, Nev.). If the test droplet was held by, and did not overrun the boundaries of the hydrophobic corral, the droplet was considered to pass. The tip of the needle that dispensed the liquid was not removed from the drop during the testing process because the shock of removing it sometimes caused droplets with low surface tensions to fail. If the probe liquid did not pass the first time the experiment was repeated. If it did not pass the second time the liquid was considered to fail. After testing with a probe liquid, the sample was rinsed with water and dried with a jet of N₂. 20 μL droplets of glycerol and ethylene glycol were dispensed with a micropipettor. At least 8 different hydrophobic corrals were tested and the results averaged under each set of conditions described herein.

Finite Element Analysis was performed with the Surface Evolver program, which is an interactive program for modeling liquid surfaces shaped by various forces and constraints. Surface tensions of 71.99 mN/m and 22.07 mN/m and densities of 0.9970 g/cm³ and 0.7855 g/cm³ for water and methanol, respectively, were employed. The datafile “mound.fe,” which models a mound of liquid sitting on a tabletop with gravity acting on it and which accompanies Surface Evolver, was modified to form a parallelpiped with a square base in which each edge has length 0.5 cm and a height of 0.08 cm, so that its volume is 20 μL. The base edges and base vertices were fixed and the gravity constant was set to 980. Surface Evolver was then run on this datafile, refining it and iterating until the desired accuracy was achieved. In this manner the drop shape was minimized with respect to the surface energy at the liquid-vapor interface and the gravitational energy. The total energy is the sum of the gravitational energy of the drop, with the base of the drop as the zero of energy, and the energy contribution from the liquid-air surface area of the drop.

Theoretical Calculations. The Silicon (100) surface was modeled as a cluster of 48 Si atoms arranged in a tetrahedral structure, and terminated with hydrogen atoms. 1-dodecene and 1-dodecyne were attached to the center of the (100) face of the cluster with their free alkyl chains in an all-trans conformation, and the geometry was optimized with an MMFF94 force field and with the PM3 semi-empirical method using the program Spartan (PC Spartan Plus 1.5.2, Wavefunction, Inc., 18401 Von Karman Ave., Ste. 370, Irvine, Calif. 92612 U.S.A). The structures from the PM3 calculations were used as the initial guess for ab initio calculations with Gaussian 98 (Gaussian 98 revision A.6, Gaussian Inc., Carnegie Office Park, Building 6, Suite 230, Carnegie, Pa. 15106 USA) using a Hartree-Fock STO-3G basis set. This result was then used as the initial guess for the next level of theory (Hartree-Fock 3-21G* basis set).

Unless otherwise specified, in SiCₓH_{y}⁺ and CₓH_{y}^{+ fragments, Si, C, and H denote} ²⁸Si, ¹²C, and ¹H, respectively, and x and y are integers. Peak areas were measured with instrument software and normalized to the areas of the ²⁸Si⁺ and ²⁸Si⁻ peaks for the positive and negative scans, respectively.

For the experiments that compared Si scribed under CH₃I to Si scribed under ¹³CH₃I, data were obtained with a Physical Electronics PHI TRIFT II Time-of-Flight Secondary Ion Mass Spectrometer, using a ⁶⁹Ga liquid metal ion gun (LMIG) primary ion source. The instrument was operated in an ion microprobe mode in which the bunched, pulsed primary ion beam was rastered across the sample's surface. The analytical area was 60×60 μm², the acquisition time was 240 s per spectrum, and no charge compensation was employed. The primary ion beam potential was 12 kV for positive ions and 18 kV for negative ions. The primary ion current (DC) was 2 nA, no masses were blanked, and the energy filter and contrast diaphragm were both used to obtain enhanced mass resolution. The mass resolution achievable using these conditions was 6500 (m/Δm at m/z 41) in positive ion mode and 5600 (m/Δm at m/z 60) in negative ion mode. These mass resolutions were somewhat below the optimal mass resolution typically obtained on a polished wafer surface and the difference was due to the roughness induced by the scratching of the wafer surface. The resolution was still sufficient to distinguish SiO₂ from ¹³CH₃SiO in negative ion mode.

Ab initio calculations: Ab initio calculations of the fragment energies were performed for the SiCH₃⁺ and SiCH₂CH₃⁺ fragments to compare the energies of different isomers. Calculations were performed using GAUSSIAN 98 on an IBM SP/2 Power 3 computer. The initial geometries were optimized using Unrestricted Hartree Fock level of theory with a 6-31G* basis set on all atoms. The energies for each fragment were then calculated at the CCSD (coupled cluster with singles and double excitations) level of theory with the CC-PVDZ basis set. The energies were calculated for the lowest singlet and triplet states for each possible isomer.

### Example 1

### XPS, TOF-SIMS, and Wetting of Monolayers on Silicon Prepared by Scribing in the Presence of 1-alkenes, Including CH₂═CH(CF₂)₅CF₃, and 1-alkynes.

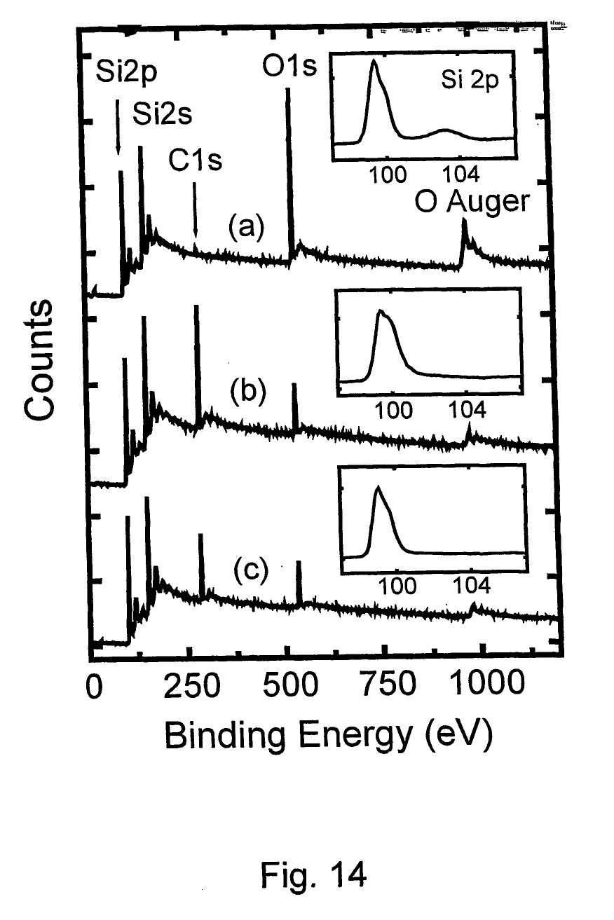

The consequences of scribing silicon in the presence of unsaturated species were studied by X-ray photoelectron spectroscopy (XPS) and time-of-flight secondary ion mass spectrometry (TOF-SIMS). FIG. 14 shows XPS survey spectra and accompanying Si 2p narrow scans (insets) of (a) a control experiment in which dry, clean silicon was first scribed in the air and then wet with 1-dodecene, and of (b) silicon that was wet with 1-dodecene and then scribed, and (c) silicon that was wet with 1-octyne and then scribed. The control surface (FIG. 14a) shows a weak C 1s signal, strong oxygen 1s and Auger signals, and a chemically shifted Si 2p peak at ˜103 eV, which indicates silicon oxide (see inset to FIG. 14a). XPS spectra from other control experiments, including dry silicon scribed in the air and dry silicon scribed in the air and then wet with 1-octyne, are virtually identical to FIG. 14a. FIGS. 14b and 14c show that when silicon is wet with an unsaturated species and then scribed, less oxygen is found on the surface than when the surface is scribed in air, a significant carbon signal appears that corresponds to monolayer quantities of alkyl chains, and significantly less silicon oxide is observed (Si 2p narrow scan insets) than when silicon is first scribed in the air.

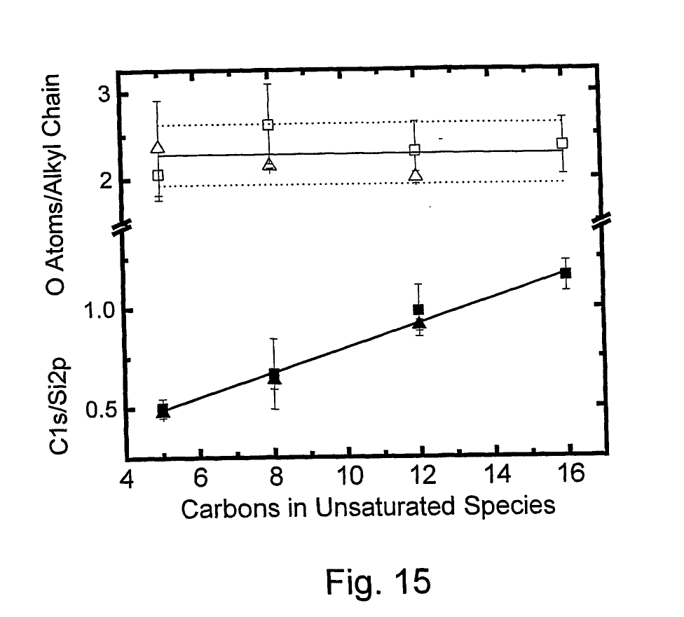

FIG. 15, which shows XPS data of surfaces that were prepared by scribing silicon in the presence of a series of 1-alkenes and 1-alkynes with different chain lengths, reveals three important features of this system.

In this figure, the ratio of the raw carbon peak area to raw silicon peak area by XPS and the number of oxygen atoms per alkyl chain, which is the product of the number of carbon atoms in the alkyl chain multiplied by the normalized O peak area divided by the normalized C peak area. Results shown were obtained from 18 surfaces: 1-alkene surfaces (squares) were made three times, and 1-alkyne surfaces (triangles) were made twice. The C1s/Si2p data are given by solid symbols, and the O atoms/Alkyl Chain data by open symbols. The fit to the C1s/Si2p data is the line passing through the solid symbols and is given by C1s/Si2p=0.062* (number of carbons in the unsaturated species)+0.18.

First, in the range of alkyl chain lengths studied, the ratio of the area of the C1s to the Si2p XPS peaks, which is a measure of the amount of carbon on the surface, depends linearly on the number of carbon atoms in the 1-alkene or 1-alkyne. Second, to within experimental error, the amount of carbon deposited on the surface is the same for 1-alkenes (solid squares) and 1-alkynes (solid triangles) with the same number of carbon atoms. Third, the number of oxygen atoms on the surface per alkyl chain (2.28±0.35) (open symbols) is independent of the number of carbon atoms in the unsaturated species.

Dry silicon substrates were wet with CH₂═CH(CF₂)₅CF₃ and then scratched with a diamond-tipped instrument. The resulting surfaces were hydrophobic. The C1s/Si2p ratio and the number of oxygen atoms per alkyl chain by XPS for these surfaces are 0.47±0.01 and 3.3±0.1, respectively. This C1s/Si2p ratio is lower than that for 1-octene and 1-octyne (˜0.67), and approximately equal to the value for 1-pentene and 1-pentyne (˜0.49) (see FIG. 15). Factors contributing to the lower carbon and higher oxygen levels in these surfaces may be 1) the larger diameter of fluorinated alkyl chains as opposed to normal alkyl chains, and 2) the lack of an allylic hydrogen in CH₂═CH(CF₂)₅CF₃. The numerical values given in this and the next paragraph are the average values from two experiments and the error is half of the difference between the data points.

Control surfaces were also characterized by XPS. Dry silicon that was scratched in the air had a C1s/Si2p ratio of 0.06±0.02. For silicon surfaces that were scribed in the air and then wet with 1-dodecene or 1-octyne, the C1s/Si2p ratios are 0.07±0.01 and 0.09±0.02, respectively, while the O/Alkyl Chain ratios are 97±20 and 50±8, respectively. As expected, the C1s/Si2p ratio is much lower and the O/Alkyl chain ratio is substantially higher for the controls than for silicon surfaces scribed in the presence of unsaturated species.

Static TOF-SIMS positive ion spectra of silicon scribed in the presence of 1-octene, 1-dodecene, 1-hexadecene, 1-octyne, and 1-dodecyne were obtained. Significant fragmentation of surface species would be expected because the energy of the primary ion source (25 keV Ga⁺) is more than 6000 times the strength of a typical covalent bond (˜4 eV). All of the spectra contain a variety of masses that correspond to hydrocarbon fragments (combinations of ¹²C and ¹H) including CₙH_{2n (n=}1-5), CₙH₂ₙ₊₁ (n=1-6), Cₙ₊₁H₂ₙ₋₂(n=2-4), Cₙ₊₁H₂ₙ (n=1-4), Cₙ₊₁H₂ₙ₊₁ (n=0-5), Cₙ₊₂H₂ₙ₋₁ (n=1-4), and Cₙ₊₂H₂ₙ₊₁ (n=0-5), as well as masses that suggest combinations of ²⁸Si, ¹²C, and ¹H such as SiCₙHₙ (n=1-4), SiCₙH₂ₙ (n=1-4), SiCₙH₂ₙ₊₁ (n=1-4),SiCₙH₂ₙ₊₃ (n=1-2), SiCₙ₊₁H₂ₙ₊₁ (n=1-3), SiCₙ₊₂H₂ₙ₊₁ (n=0-3), Si₂CH, and Si₂C₂H. The fragments that contain Si, C, and H are suggestive of covalent bonding of alkyl chains to the silicon surface. Nevertheless, the possibility that atomic and/or molecular fragments may combine in the high pressure region immediately above the sample to produce some of the results observed cannot be eliminated at present. Either Si⁺ or SiH⁺ was the base peak (most intense feature) in all of the spectra, and Si₂⁺ is also present in all of the spectra.

### Example 2

### XPS of Silicon Scribed Under 1-alkenes, 1-alkynes, and 1-haloalkanes

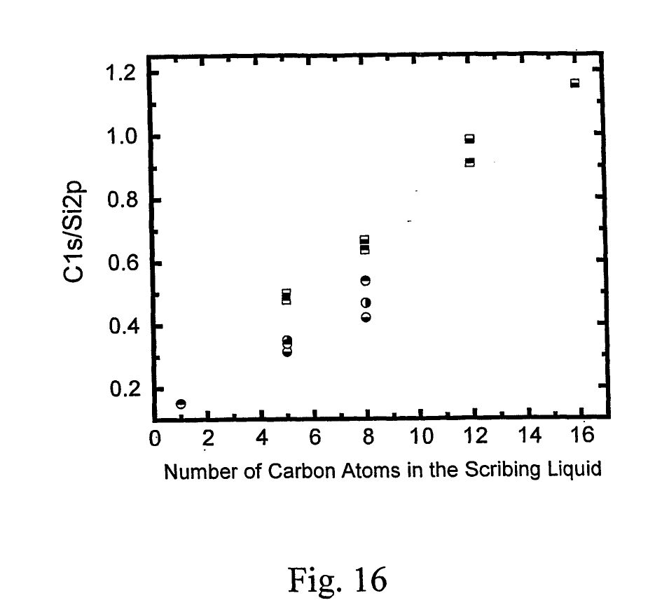

The XPS data shown in FIG. 16, which was compiled from work on silicon scribed under 1-alkenes, 1-alkynes, and 1-haloalkanes. The ratio of areas of the uncorrected C1s XPS peak to the Si 2p XPS peak for 1-alkenes and 1-alkynes (squares: upper half black (1-alkynes), lower half black (1-alkenes)) and 1-haloalkanes (circles: upper half black (1-iodoalkanes), right side black (1-bromoalkanes), lower half black (1-chloralkanes)). These data contain three important features that will be compared to trends in ToF-SIMS data First, 1-alkene and 1-alkyne scribing liquids with the same number of carbon atoms produce surfaces with similar C1s/Si2p ratios, and 1-chloro-, 1-bromo-, and 1-iodoalkanes with the same number of carbon atoms also produce surfaces with similar C1s/Si2p ratios. Second, for the 1-alkenes, 1-alkynes, and 1-haloalkanes, the amount of carbon on the surfaces increases with increasing chain length of the scribing liquid. Third, silicon scribed under 1-alkenes and 1-alkynes has higher C1s/Si2p ratios than silicon scribed under 1-haloalkanes with the same number of carbon atoms, i.e., there is more carbon present on silicon scribed under 1-alkenes and 1-alkynes than on silicon scribed under 1-haloalkanes. The previously proposed mechanisms suggest a plausible explanation for this last result: 1-alkenes and 1-alkynes bind directly to scribed silicon to occupy two surface sites, but for the alkyl chain in a 1-haloalkane to bind, the surface must first abstract a halogen atom from it to produce a radical. It is unlikely that this alkyl radical will diffuse back to and bind with the surface with complete certainty. Consequently, more surface sites will be occupied by halogen atoms than by alkyl chains. Thus, the density of alkyl chains on silicon scribed under 1-alkenes and 1-alkynes is expected to be greater than the density of alkyl chains on silicon scribed under 1-haloalkanes.

### Example 3

### Relative ToF-SIMS Intensities of SiCₓH_{y}⁺ Peaks

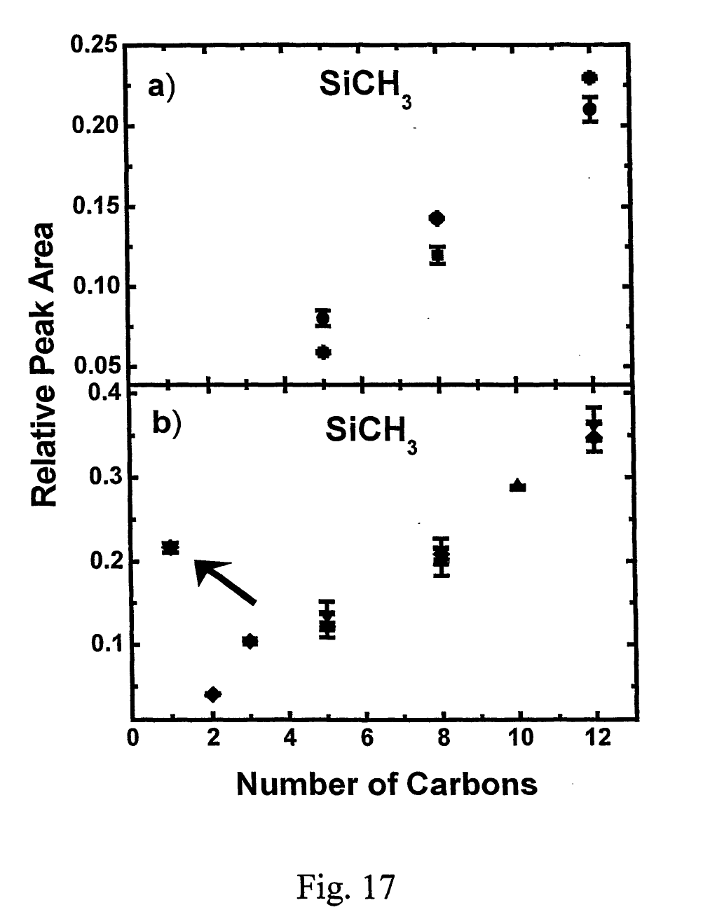

FIGS. 17-20 show static ToF-SIMS intensities, normalized with respect to Si⁺, of SiCH₃⁺, SiC₂H₅⁺, SiC₃H₇⁺, and SiC₄H₉⁺ as a function of the number of carbons in the scribing liquid (the top panel in each figure is for 1-alkenes and 1-alkynes and the bottom is for 1-chlorro-, 1-bromo-, and 1-iodoalkanes). These spectra illustrate six important trends or salient features. First, as was the case for the XPS data in FIG. 16, surfaces prepared with a given 1-alkene yield fragments with approximately the same normalized intensities as surfaces prepared with a 1-alkyne with the same number of carbon atoms (top panels). Surfaces prepared with the three 1-haloalkanes also show the same pattern (bottom panels). These result support the proposed binding model as they suggest structural similarities between surfaces derived from 1-alkenes and 1-alkyenes, and similarities between those prepared from the three 1-haloalkanes.

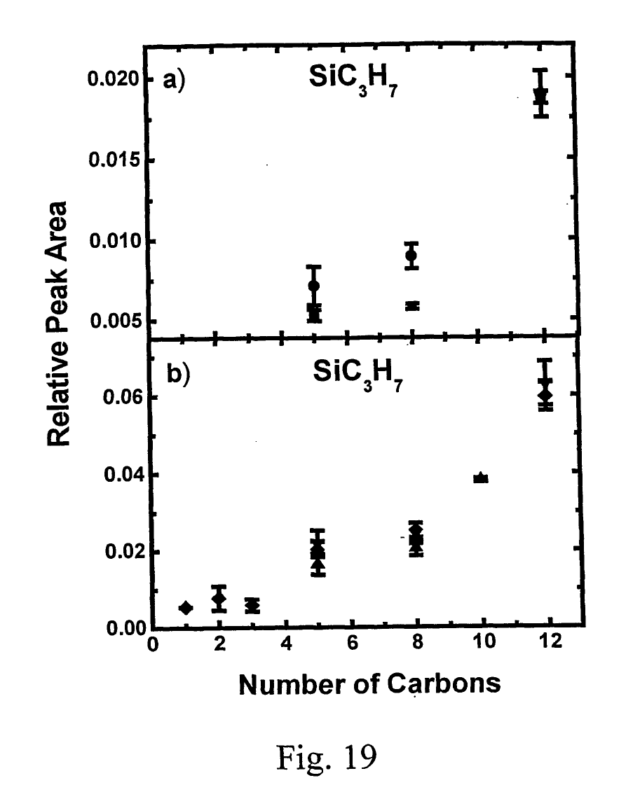

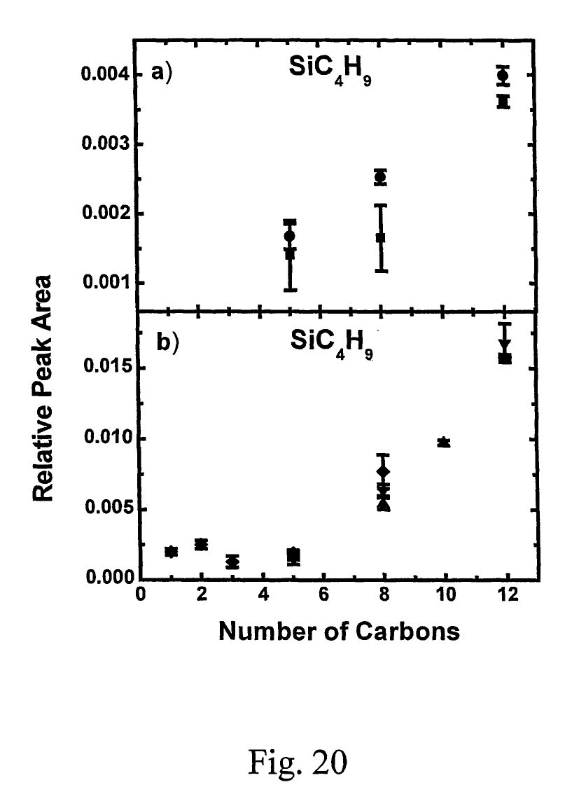

Second, similar to the XPS results, the intensity of a given fragment generally increases as the number of carbons in a scribing liquid increases, which points to sputter-induced decomposition (and recombination) at the surface. However, for fragments from surfaces prepared from light 1-haloalkanes the data are often low in intensity and approximately equal to each other before this trend is observed, e.g., see FIGS. 19 and 20. These results are consistent with the proposed binding model. That is, it is reasonable to assume that it would be difficult to produce fragments with a large number of carbon atoms from surfaces that were prepared from the lighter 1-haloalkanes, but above a certain threshold, more carbon on the surface would be expected to yield more intense SiCₓH_{y}⁺ fragments.

Third, in a homologous series of a type of fragment, e.g., SiCₙH₂ₙ₊₁⁺, n=1-4 in FIGS. 17-20, the average relative intensity usually decreases with n, indicating that it becomes increasingly difficult to make larger fragments.

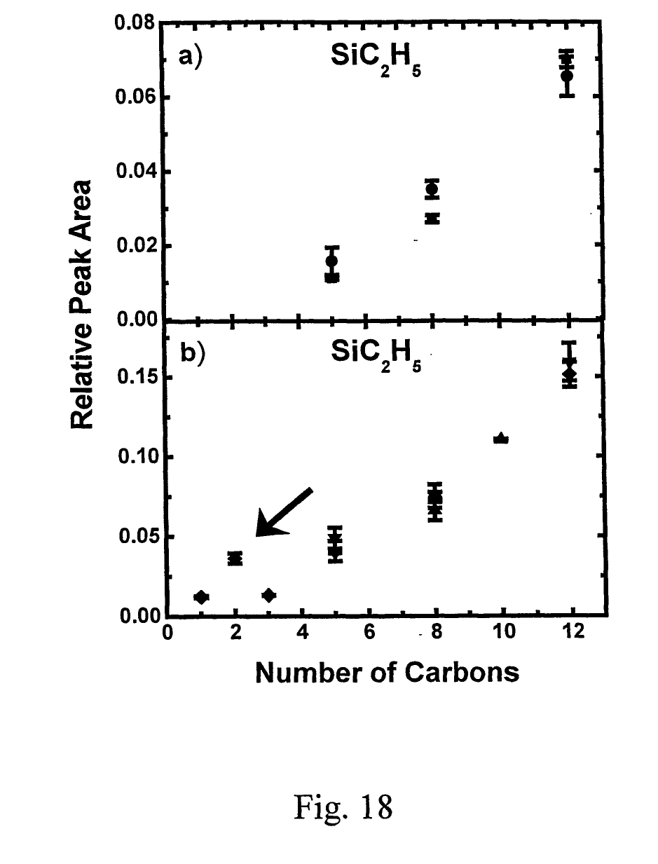

Fourth, the intensities of the SiCH₃+fragment from silicon scribed under ICH₃ in FIG. 17b and the SiCH₂CH₃⁺ fragment from silicon scribed under ICH₂CH₃ in FIG. 18b are anomalously strong, in contrast to the second trend mentioned above. These results are consistent with the expected fragmentation from methyl- and ethyl-terminated silicon and support the proposed binding model. However, this anomalous behavior does not continue for the SiCH₂CH₂CH₃⁺ fragment from silicon scribed under ICH₂CH₂CH₃ (FIG. 19b).

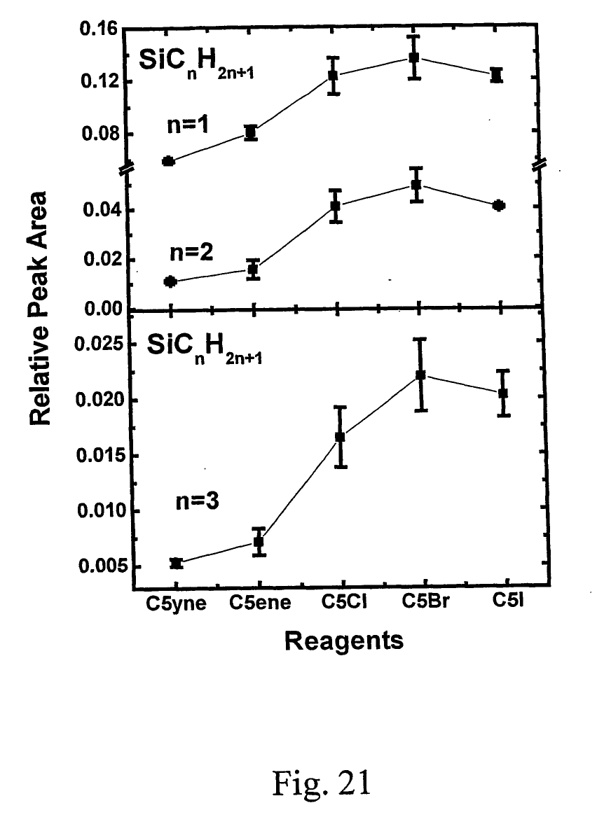

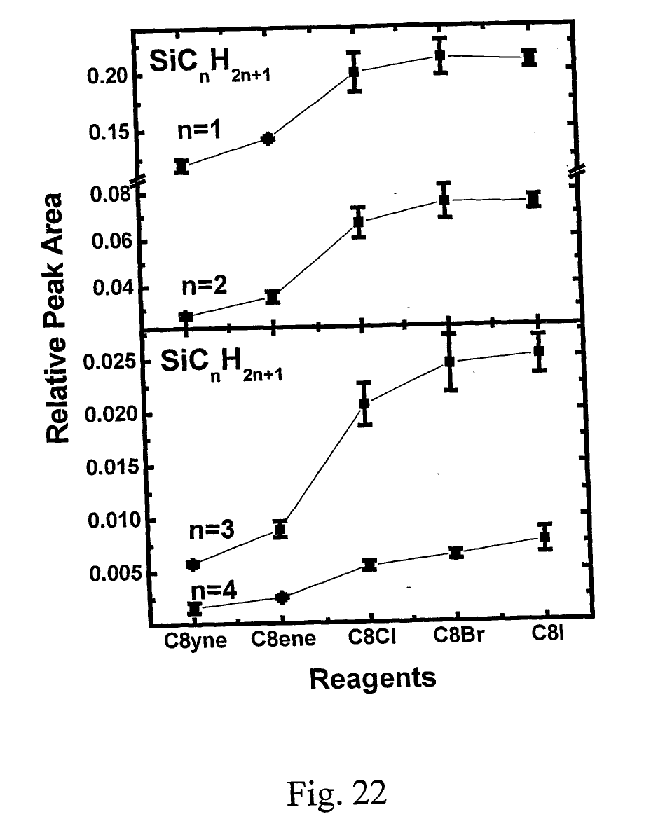

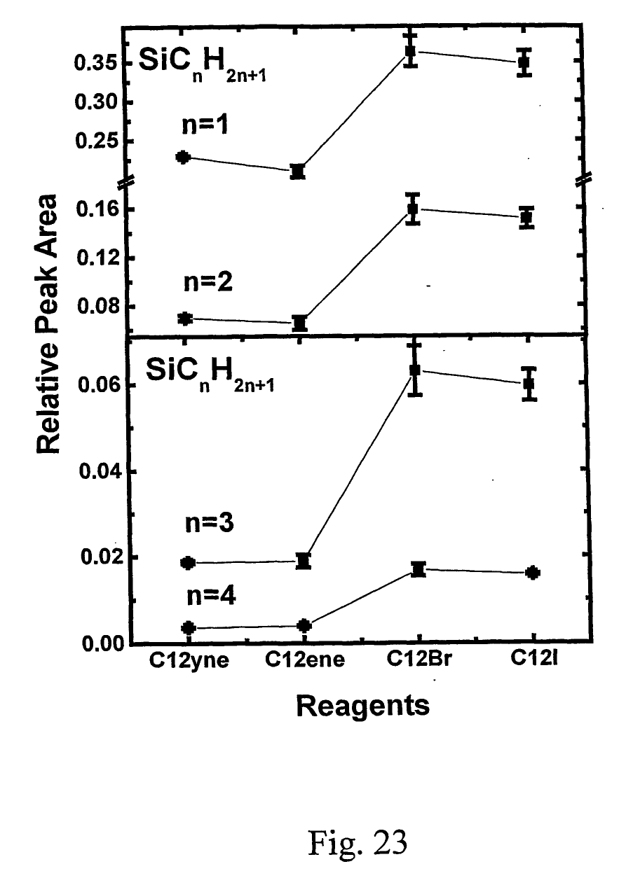

FIGS. 21-23, which were obtained by grouping SiCₓH_{y}⁺ data according to the number of carbons in the scribing liquid, illustrate a fifth important point. FIGS. 21 shows relative intensities of SiCₙH₂ₙ₊₁⁺ signals (n=1-3) from 1-pentyne (C5yne), 1-pentene (C5ene), 1-chloropentane (C5C1), 1-bromopentane (C5Br), and 1-iodopentane (C5I). The n=4 fragments were very weak and did not follow any particular pattern. FIG. 22 shows relative intensities of SiCₙH₂ₙ₊₁⁺ signals (n=1-4) from 1-octyne (C8yne), 1-octene (C8ene), 1-chlorooctane (C8Cl), 1-bromooctane (C8Br), and 1-iodooctane (C8I). FIG. 23 shows Relative intensities of SiCₙH₂ₙ₊₁⁺ signals (n=1-4) from 1-dodecyne (C12yne), 1-dodecene (C12ene), 1-bromododecane (C12Br), and 1-iodododecane (C12I).

These figures show that, in contrast to XPS results that show that silicon scribed under 1-alkenes and 1-alkynes has more carbon present than silicon scribed under 1-haloalkanes with the same number of carbon atoms, SiCₓH_{y}⁺ fragment intensities from silicon scribed under 1-haloalkanes are generally more intense than, even sometimes more than twice as intense, as fragments from silicon scribed under 1-alkenes and 1-alkynes. This trend is also repeated in the case of other fragments. It is reasonable to expect that it would be easier to create SiCₓH_{y}⁺ fragments from alkyl chains tethered through a single C—Si bond, which are predicted to form in silicon scribed under 1-haloalkanes, than from alkyl chains tethered through two C—Si bonds, which are predicted for silicon scribed under 1-alkenes and 1-alkynes.

FIGS. 21-23 illustrate a sixth trend that is closely related to but less pronounced that the fifth trend described above. In general, these figures show that relative intensities of SiCₓH_{y}⁺ fragments derived from surfaces prepared with 1-alkenes are more intense than the same fragments from surfaces prepared with 1-alkynes, which contain the same number of carbon atoms. These results are consistent with the proposed structures in FIG. 2. That is, it is reasonable to expect that it would be more difficult to produce SiCₓH_{y}⁺ fragments from alkyl chains bonded as shown in FIG. 2a (from 1-alkynes) than from those shown in FIG. 2b (from 1-alkenes).

### Example 4

### Relative ToF-SIMS Intensities of CₓH_{y}⁺ Peaks

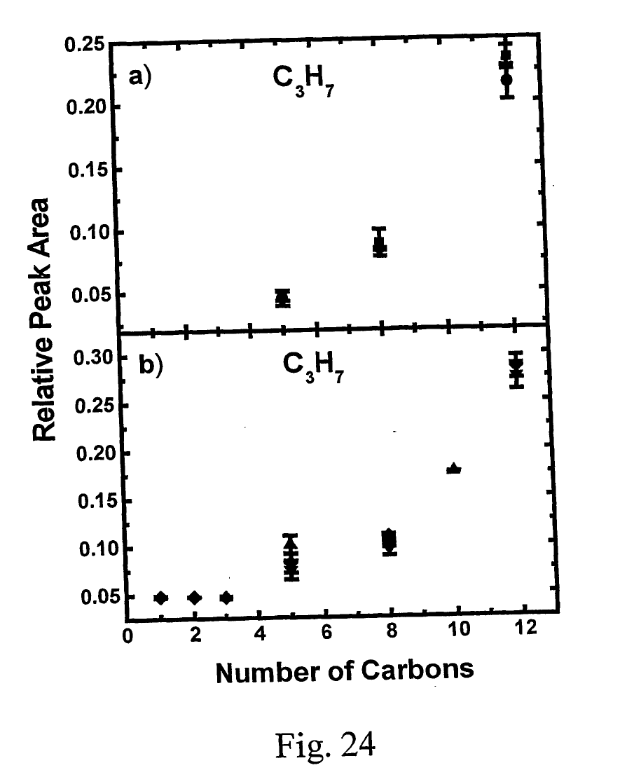

FIG. 24 shows the intensity of the C₃H₇⁺ fragment from silicon scribed under homologous series of 1-alkenes, 1-alkynes, and 1-haloalkanes. These data are in agreement with some of the trends or salient features noted above for SiCₓH_{y}⁺ type ions. For example, in agreement with the fourth point, the intensities of the CH₂⁺ and CH₃⁺ fragments from silicon scribed under CH₃I are anomalously strong.

However, this data does not follow trend three. That is, for a given type of CₓH_{y}⁺ ion, the relative intensity may increase as the number of carbon atoms in the ion increases. For example, pairs of homologous SiCₓH_{y}⁺ type ions from silicon scribed under 1-dodecene and 1-dodecyne follow trend three and decrease with increasing numbers of carbon atoms (the average intensity is denoted by I): [SiCₙH₂ₙ₊₁⁺: I(SiCH₃⁺)˜0.22, I(SiC₃H₇⁺)˜0.017]; [SiCₙH₂ₙ⁺)˜0.050, I(SiC₃H₆⁺)˜0.0043]; [SiₙH₂ₙ₋₁⁺: I(SiC₂H₃^{+)˜}0.027, I(SiC₃H₅+) 0.0045). However, the analogous CₓH_{y}^{+ type ions increase in intensity, or their intensities remain nearly constant, as the number of carbon atoms in them increase: [C}ₙH₂₊₁⁺: I(CH₃⁺)˜0.10, I(C₃H₇⁺)˜0.23]; [CₙH₂ₙ⁺: I(CH₂⁺)˜0.020, I(C₃H₆⁺)˜0.053]; [CₙH₂ₙ₋₁⁺: I(C₂H₃⁺)˜0.56, I(C₃H₅^{+)˜}0.46]. For larger (four-carbon and five-carbon) CₓH_{y}⁺ ions the intensities then decrease: I(C₄H₇⁺)˜0.054, I(C₄H₈⁺)˜0.007, I(C₄H₉+) 0.020, I(C₅H₁₀⁺)˜0.0009, I(C₅H₉⁺)˜0.005.

### Example 5

### Isotopic Labeling Studies: Si Scribed Under CH₃I and ¹³CH₃I

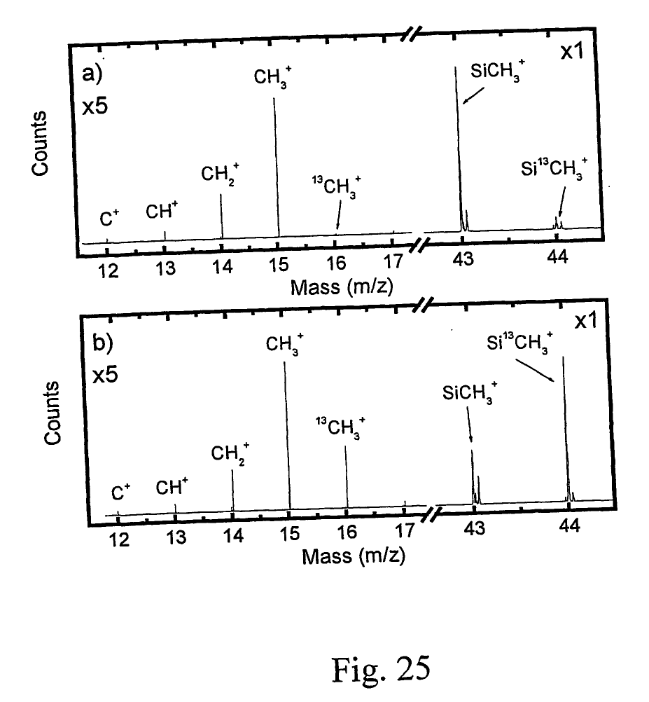

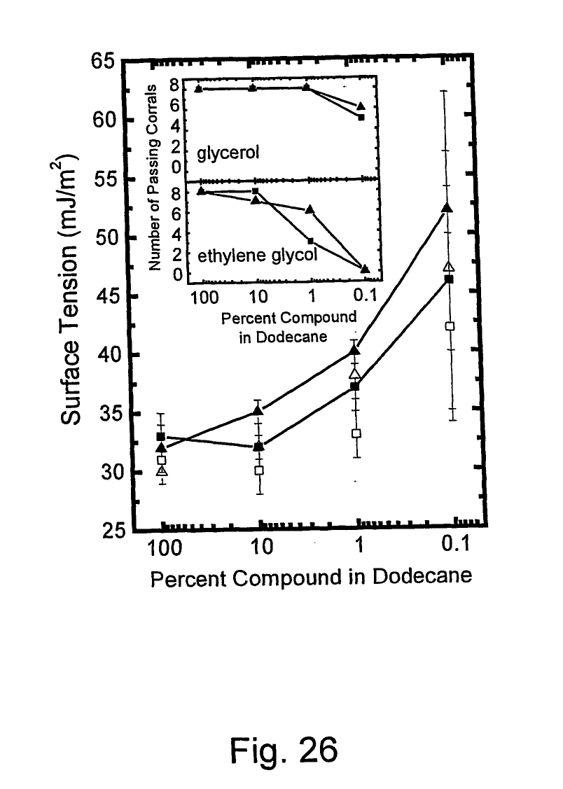

To obtain a deeper understanding of monolayers on scribed silicon prepared from 1-haloalkanes, silicon was scribed under both CH₃I and ¹³CH₃I, as shown in FIG. 26. This study yielded two valuable pieces of information. First, prominent peaks due to ¹³CH₃⁺ and Si¹³CH₃⁺ were only observed in silicon scribed under ¹³CH₃I (see FIG. 25), providing additional evidence for formation of methyl-terminated silicon from silicon scribed under methyl iodide. Second, a significant peak due to and SiCH₃⁺ was observed in spectra from surfaces made with both the labeled and unlabeled materials (see FIG. 25). If it is assumed that only methyl groups from labeled or unlabeled methyl iodide bind to the surface during monolayer formation, these results suggest sputter-induced decomposition (and recombination) of adventitious hydrocarbons with silicon atoms from the substrate.

Tables 2 and 3 (1 and 2 from Langmuir manuscript) list prominent negative and positive ions for these surfaces (with their duplicates), respectively. For both the labeled and unlabeled surfaces, Table 2 shows similar amounts of CH⁻, O⁻, OH⁻, C₂H⁻, Si⁻, SiO₂⁻, SiO₂⁻, SiO₂H^{-, and SiO}₃H⁻, and significant differences between the labeled and unlabeled surfaces in CH₃SiO⁻, ¹³CH₃SiO⁻; CH₃SiO₂⁻, ¹³CH₃SiO₂⁻, ¹³CH₃⁺, CH₃Si⁺, ¹³CH₃Si⁺, C₃H₉Si⁺, and ¹³C₃H₉Si⁺. The variations between sets of duplicates in the results in Tables 2 and 3 may be due to spot-to-spot variability in the coverage of the ¹³C enriched species, since it is unlikely that exactly the same area was analyzed in positive and negative ion modes. We attribute the presence of the NH₄⁺ ion to the silicon cleaning solution (NH₄OH/H₂O₂).

### Example 6

### Ab Initio Calculations of SiCₓH_{y}⁺ Species

In order (1) to confirm that appropriate fragment structures are assigned to masses, and (2) to better understand what level of theory is appropriate for evaluating cationic fragments that contain Si, C and H, ab initio calculations were performed on SiCH₃⁺ and SiC₂H₅⁺. The positions of the hydrogen atoms in the structures were varied and the resulting fragments were considered in their singlet and triplet states at Hartree-Fock, MP2 and CCSD levels of theory.

For fragments that correspond to m/z 43.00 (1 Si, 1 C, and 3 H) (see Table 4), all three levels of theory indicate that singlet SiCH₃⁺ is more stable than triplet or singlet SiHCH₂⁺, SiH₂CH⁺, or SiH₃C⁺ (and triplet SiCH₃⁺). This result is not unexpected because the Si—H bond is weaker than the C—H bond. Thus, SiCH₃⁺ is a logical assignment for the peak at m/z 43.00. Table 5 contains ab initio calculations for fragments that correspond to m/z 57.02 (1 Si, 2 C, and 5H). Again the singlet energies are generally much lower than the triplet energies. Out of the singlet structures considered four of them have significantly higher energies than the remaining fragments and are therefore not reasonable structures. The H₂SiCH₂CH⁺ fragment could not be optimized because it converted to the H₂SiCHCH₂⁺ fragment, so no energy is given. Unlike the calculations in Table 4 which clearly indicated a lowest energy structure, the results in Table 5 suggest that the remaining four singlet structures: SiCH₂CH₃⁺, HSiCHCH₃⁺, HSiCH₂CH₂⁺ and H₂SiCHCH₂⁺ are all within 15 kJ/mol of the lowest energy fragment H₂SiCHCH₂⁺. They are therefore all possible assignments for the SiC₂H₅⁺ fragment. It is somewhat surprising that the calculated energy for the H₂SiCHCH₂ is lower than the SiCH₂CH₃⁺ fragment, given that the Si—H bond is weaker than the C—H bond, however the calculations show that the H₂SiCHCH₂⁺ fragment forms a partial three-membered ring with the Si and the two carbons, and this may explain its low energy. The calculations also show that the Hartree Fock level of theory is insufficient to give quantitative results for these fragments, but that both the MP2 and the CCSD levels of theory give better predictions of the energy.

The proposed binding models for 1-alkenes, 1-alkynes, and 1-haloalkanes on scribed silicon are supported by the following results:

1. Silicon scribed with a given 1-alkene produces SiCₓH_{y}⁺ and CₓH_{y}⁺ fragments that are roughly equivalent (usually slightly higher) in intensity than the same fragments obtained by scribing silicon under a 1-alkyne with the same number of carbon atoms. Silicon pieces scribed with different 1-haloalkanes, differing only in the identity of the halogen, show similar behavior.

2. The intensity of the SiCₓH_{y}⁺ or CₓH_{y}⁺ fragments shown in FIGS. 17-20 and 24, generally increase with increasing chain length of the scribing liquid.

3. Direct evidence for the formation of methyl- and ethyl-terminated silicon is provided by anomalously intense SiCH₃⁺ and SiCH₂CH₃⁺ signals from silicon scribed under ICH₃ and ICH₂CH₃, respectively. An isotopic labeling study provides additional evidence for the formation of methyl-terminated silicon by scribing silicon under methyl iodide. @4. In contrast to XPS results that show that silicon scribed under 1-alkenes and 1-alkynes has more carbon than silicon scribed under 1-haloalkanes with the same number of carbon atoms, SiCₓH_{y}⁺ fragment intensities from silicon scribed under 1-haloalkanes are generally more intense than fragments from silicon scribed under 1-alkenes and 1-alkynes.

5. Surfaces prepared from 1-alkynes generally show less intense SiCₓH_{y}⁺ fragments than surfaces prepared from 1-alkenes with the same number of carbon atoms.

### Example 7

### Formation of Hydropbobic Corrals from Neat and Diluted Compounds, and Wetting of and Functionalization in Hydrophobic Corrals

A surface was prepared by scratching silicon that was wet with 1-hexadecene with a diamond scribe. Following an initial cleaning by rinsing with copious amounts of acetone and water, the surface was exposed overnight to recirculated hot m-xylene (b.p. 138° C.) in a Soxhlet extractor, highly efficient degreasing conditions, and then immersed in boiling water for 1 hour. 28 water droplets in a grid of hydrophobic lines, 0.5 cm apart, on a silicon surface, which was turned on its side (vertically) were retained within the corrals. That the individual hydrophobic corrals still hold distinct water droplets after these stability experiments, even in the geometry shown, shows a high level of stability of these monolayer coatings and father suggests covalent surface attachment of 1-hexadecene to silicon.

Scanning electron microscopy showed that the width of scribed lines is 50-100 μm and that their interiors and edges are rough. Profilometry also indicated that the lines are rough and puts a lower limit on their depth (4.2±1.4 μm). A more thorough characterization of scribed surfaces by atomic force microscopy showed that the roughened surface features vary in width from ˜100 nm to >5 μm, and that these bumps had a low height to width ratio (typically 1:10 and infrequently greater than 1:5). Some relatively flat areas (as large as 10 μm²) were occasionally observed; the root mean square roughness of these areas was as low as 7 nm for a 2.5 μm×2.5 μm region with 50 nm height range. The depth of scribed lines varied from as small as 1 μm to greater than the range of the scanner (5.5 μm).

### Example 8

### Dilution Studies

FIG. 25 shows the passing and failing surface tensions of 20 μL methanol-water, glycerol, and ethylene glycol test droplets in hydrophobic corrals, which were prepared by scribing silicon in the presence of 1-dodecene and 1-octyne at 100%, 10%, 1%, and 0.1% (v/v) dilution in dodecane. The figures shows passing (solid symbols) and failing (open symbols) surface tensions of 20-microliter methanol-water test droplets in hydrophobic corrals made from 1-dodecene (squares) and 1-octyne (triangles), which were diluted in dodecane. The insets show the number of hydrophobic corrals out of 8 tested, which held droplets of glycerol and ethylene glycol. The results at 100% (neat compounds) and 10% dilution are nearly the same. However, at 1% and to a greater extent at 0.1% dilution, the hydrophobic corrals begin to lose their ability to hold test droplets with low surface tensions.

Nevertheless, unlike hydrophobic corrals formed with dodecane, those made with 0.1% 1-dodecene and 1-octyne still have not completely lost their ability to hold methanol-water or glycerol test droplets.

A possible explanation for the trend shown in FIG. 25 is that dissolved oxygen begins to compete effectively with 1-alkenes and 1-alkynes, when their concentrations are sufficiently low. Indeed, at 0.1% (v/v) dilution in dodecane, the concentrations of 1-dodecene (4.5 mM) and 1-octyne (6.8 mM) are relatively close to that of oxygen in hydrocarbons: ˜2 mM, an estimate based on the solubility of oxygen in decane, using dodecane's physical constants, and assuming 21% oxygen in the air and that the different liquid volumes in the mixtures are additive. If this explanation is correct, it suggests similar reaction rates for oxygen, 1-alkenes, and 1-alkynes with scribed silicon.

### Example 9

### Interior Surface Functionalization of Hydrophobic Corrals

When hydrophobic corrals are prepared, only the scribed lines are functionalized, and not the unmarked silicon/silicon oxide. Polyelectrolyte multilayer deposition was used to show that underivatized interior regions of hydrophobic corrals can be selectively functionalized, and not the surrounding regions or neighboring corrals.

In polyelectrolyte deposition it is believed that an electrostatic attraction between a surface and a solvated polyelectrolyte drives film formation and that an electrostatic repulsion between adsorbed polymer chains and those in solution limits deposition to essentially monolayer quantities. Part of the droplet is then removed and replaced by a polymer solution to give a certain concentration above the surface. After a given amount of time to allow polelectrolyte deposition, the region is rinsed by repeatedly removing some of the liquid from the drop and replacing it with water. The next polyelectrolyte layer is then deposited by replacing some of the water in the droplet in the corral with a different polymer solution. In this manner polyelectrolyte multilayers are deposited in the interior regions of hydrophobic corrals.

Polyelectrolyte adsorption, using poly(sodium 4-styrenesulfonate) (PSS) and poly(allylarnine hydrochloride) (PAH), was followed with variable angle spectroscopic ellipsometry. Because the optical constants for SiO₂ and most organics are very similar and ellipsometry is quite insensitive to changes in optical constants of very thin films (<50 Å), the adsorbed polymer and silicon oxide layers could be modeled as a single layer of silicon oxide on silicon using tabulated optical constants for these materials. The thickness of the initial sticking layer of poly(ethylenimine) (PEI) and silicon oxide was subtracted from the total film thicknesses giving 10.3±0.5 Å and 17.4±0.5 Å for PSS/PAH and (PSS/PAH)₂ multilayers, respectively. The thicknesses of two surfaces containing single PEI layers, which were deposited in the interior regions of hydrophobic corrals by the method described here, were measured with spectroscopic ellipsometry to be 3.8 Å and 3.9 Å. XPS confirmed the presence of nitrogen in these PEI layers.

### Example 10

### Theoretical Modeling of Unsaturated Species on Silicon

The XPS data show that 1-alkenes and 1-alkynes with the same chain length form thin films on scribed silicon that have the same amount of carbon (C1s/Si2p ratio). However, wetting data indicate that monolayers derived from 1-alkynes are more hydrophobic than those produced from 1-alkenes. While we have not determined the mechanism of binding of alkyl chains to silicon in this work, one possible explanation for these results is a difference in orientation between alkyl tails of 1-alkenes and 1-alkynes that might bind to silicon by a [2+2] addition mechanism.

FIG. 26, Table 6, and Table 7 show results of molecular mechanics, semi-empirical, and ab initio quantum calculations of 1-dodecene and 1-dodecyne bonded to the (100) face of a silicon cluster with 48 silicon atoms through two carbon-silicon bonds. A covalent bond links the two silicon atoms that these carbons are bonded to, and the alkyl chains are numbered consecutively starting at the unsaturated end of the chain, with C(1) bonded to Si(1), and C(2) to Si(2). FIG. 26 clearly shows that the alkyl chain in 1-dodecene tilts significantly (note the Si(1)-C(1)-C(2)-C(3) dihedral angle in Table 6 and also that different chains would be expected to tilt to the right or to the left depending on how they are attached to the surface), while the alkyl chain of 1-dodecyne does not tilt appreciably (note the Si(1)-C(1)-C(2)-C(3) dihedral angle in Table 7). Another measure of tilt, which is about the same for both adsorbed species, is the C(1)-C(2)-C(4) angle minus 90°, where the vector connecting C(2) and C(4) is essentially the chain axis because the angle C(2)-C(4)-C(6) is nearly equal to 180° for the different chains (see Tables 6 and 7). Every level of theory that these systems were examined with supports these general conclusions. Thus, alkyl chains in monolayers of 1-alkenes, if bonded as shown in FIG. 26, are expected to have more difficulty packing than alkyl chains from 1-alkynes. They would further be expected to expose more methylene units at their surfaces than monolayers of 1-alkynes, and therefore have higher surface tensions, as is observed.

The bond distances predicted by the different levels of theory in Tables 6 and 7 are in good agreement, as has been observed in theoretical calculations of bonding between second and third row elements in a wide variety of compounds. However, the bond angles sometimes differ substantially, even between the STO-3G and 3-21G* Hartree-Fock basis sets. The 3-21G* basis set is assumed to produce more accurate results because it incorporates d-type functions, while the STO-3G is a minimal basis set that does not. For 1-dodecene (Table 6) the C(1)-Si(1)-Si(2)-C(2) and Si(1)-C(1)-C(2)-C(3) dihedral angles change from 9.38° and 133.64° (STO-3G) to 5.91° and 137.34° (3-21G*), respectively. For 1-dodecyne (Table 7) the C(1)-C(2)-C(4)-90° angle changes substantially going from the STO-3G (7.28°) to the 3-21G* basis set (5.11°). Overall, the results of the different levels of theory are more consistent for the 1-dodecyne system than for that of 1-dodecene, probably because of the higher symmetry of the 1-dodecyne/silicon cluster.

### Example 11

### Deposition of Different Monolayers on Surface

Different monomolecular layers were created in distinct areas of a surface; i.e., the different reactive species were used to form distinct patches on a surface. A piece of silicon was wet with 1-pentene, and an area of the silicon surface was scribed. The scribing process was automated; a computer was used to control three translation stages that held and moved a spring-loaded diamond tip across the silicon surface. The computer can also be programmed to dispense the liquid reactive species. The following figure is an example of a surface with patches of different monolayer coatings:

| | A | B | C | D | E |
|---|---|---|---|---|---|
| 1 | 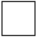 | 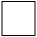 | 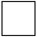 | 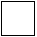 | 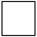 |
| 2 | 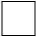 | 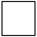 | 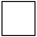 | 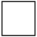 | 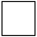 |

Each of the small boxes represents a small scribed region. For example, the area A1 might have a monolayer coating derived from 1-pentene, B1 from 1-hexene, C1 from 1-heptene, D1 from 1-octene, etc.

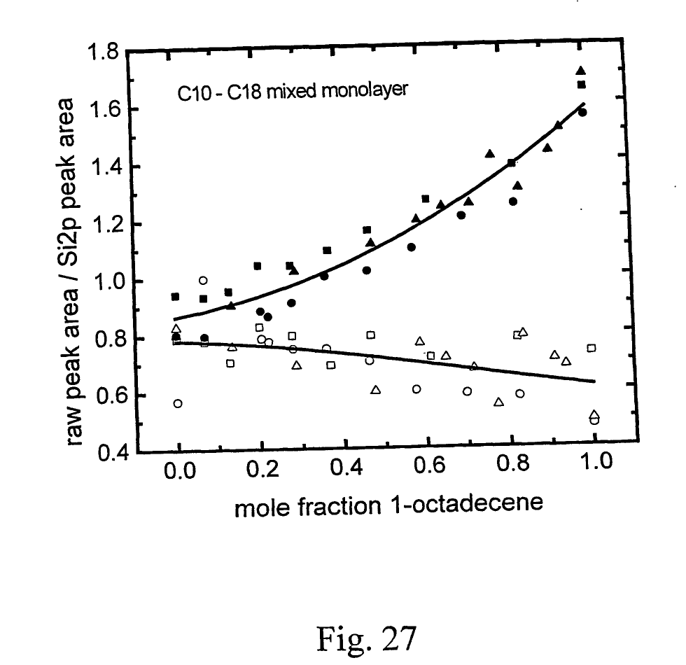

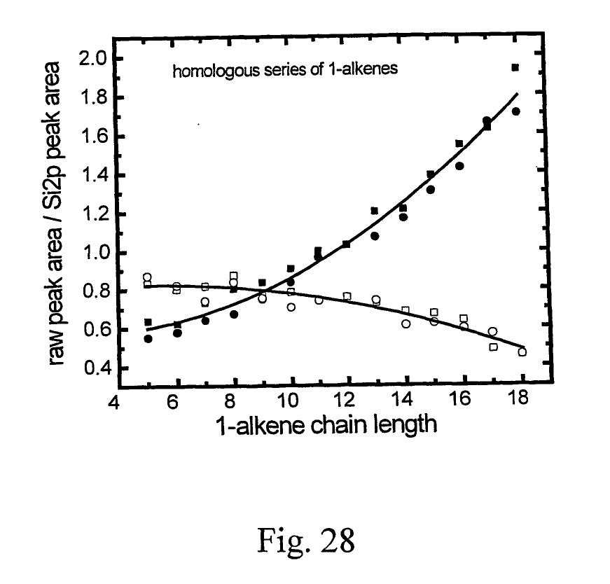

The surface was rinsed with an organic solvent and dried. The surface was then wet with 1-hexene and scribed in a region different from the first. The surface was again rinsed and dried. The process was continued with 1-alkenes up to 1-octadecene. The results are shown-in FIGS. 27 and 28. FIG. 27 shows XPS measurements of the patches. Solid symbols show the C1s/Si2p ratio and open symbols show the O1s/Si2p ratio. The squares and circles represent data taken from two different arrays. In FIG. 28, the squares, circles, and triangles represent data taken from three different arrays. As can be seen from these figures, distinct patches of different monolayers were formed on the same surface. Example 12

### Formation of Shallow Features on Silicon Surface

A tungsten-carbide ball was used to make lines on hydrogen-terminated silicon. This is distinct from silicon containing a thin oxide layer, as used in earlier examples. The lines ranged in width from 15 to 35 μm. The depth of the line could be controlled by varying the size of the ball and the pressure used while scribing. AFM showed that the depth of the lines ranged from 5 to 20 Å deep. This technique can be used to make very fine features on surfaces and may be a useful replacement for microcontact printing in some applications.

### Example 13

### Functionalization of Quartz Surfaces

Quartz surfaces were cleaned as described above for silicon surfaces and then scribed in the presence of 1-octene, 1-octyne, and 1-iodooctane. After rinsing the surfaces with acetone, rubbing them with a soft camel-hair brush and a 2% sodium dodecyl sulfate solution, and finally rinsing them with water, the quartz surfaces showed substantial C1s/Si2p ratios (raw peak areas) by XPS: 0.5, 0.6, and 0.5, respectively.

All publications and patents mentioned in this application are herein incorporated by reference to the same extent as if each individual publication or patent was specifically and individually indicated to be incorporated by reference.

A number of embodiments of the invention have been described. Nevertheless, it will be understood that various modifications may be made without departing from the spirit and scope of the invention. Accordingly, other embodiments are within the scope of the following claims.

TABLE 1

| Reagent | γpass | γfail | Cls/Si2s |
|---|---|---|---|
| Controls | | | |
| air | | 72.8 ± 0 | 0.05 |
| water | | 72.8 ± 0 | 0.07 |
| n-octane | | 72.8 ± 0 | |
| CF₃(CF₂)₆CF₃ | | 72.8 ± 0 | |
| n-dodecane | | 72.8 ± 0 | |
| Alkenes | | | |
| 1-pentene | 54 ± 10 | 49 ± 8 | 0.46 |
| 1-octene | 37 ± 2 | 33 ± 2 | 0.74 |
| 1-dodecene | 33 ± 2 | 31 ± 1 | 0.99 |
| 1-hexadecene | 31 ± 1 | 29 ± 1 | 1.08 |
| CF₃(CF₂)₅CH═C | | | |
| H₂ | 27 ± 1 | 24 ± 1 | |
| 10% dodecene in | 32 ± 3 | 30 ± 2 | |
| dodecane | | | |
| 1% dodecene in | 37 ± 2 | 33 ± 2 | |
| dodecane | | | |
| 0.1% dodecene in | 46 ± 11 | 42 ± 8 | |
| dodecane | | | |
| Alkynes | | | |
| 1-pentyne | | | 0.38 |
| 1-octyne | 32 ± 2 | 30 ± 1 | 0.58 |
| 1-dodecyne | 29 ± 1 | 27 ± 1 | 0.92 |
| 10% 1-octyne in dodecane | 35 ± 1 | 32 ± 1 | |
| 1% 1-octyne in dodecane | 40 ± 1 | 38 ± 2 | |
| 0.1% 1-octyne in dodecane | 52 ± 10 | 47 ± 7 | |
| Alcohols | | | |
| 1-octanol | 35 ± 0 | 32 ± 0 | |
| 10% 1-dodecanol in dodecane | 30 ± 2 | 28 ± 2 | 0.71 |
| 1% 1-dodecanol in dodecane | 31 ± 1 | 29 ± 1 | |
| 0.1% 1-dodecanol in dodecane | 37 ± 2 | 33 ± 2 | |
| Monomers | | | |
| docecylacrylate | 32 ± 1 | 29 ± 1 | 1.01 |
| 10% styrenein dodecane | 72.8 ± 0 | 60 ± 0 | 0.68 |
| Alkyl Halides | | | |
| methyl iodide | | | 0.11 |
| 1-chloropentane | 40 ± 3 | 37 ± 4 | |
| 1-bromopentane | 38 ± 4 | 36 ± 4 | |
| 1-iodopentane | 42 ± 5 | 39 ± 5 | 0.32 |
| 1-chlorooctane | 35 ± 0 | 32 ± 0 | |
| 1-bromooctane | 37 ± 3 | 34 ± 3 | |
| 1-iodooctane | 33 ± 1 | 30 ± 1 | 0.55 |

TABLE 2
Normalized intensities of various negative ions of interest
(Normalized relative to ²⁸Si, × 10)

| m/z | Species | Si/CH₃I | Si/CH₃I | Si/¹³CH₃I | Si/¹³CH₃I |
|---|---|---|---|---|---|
| 13.0078 | CH | 36.87 | 47.35 | 31.77 | 40.14 |
| 15.9946 | O | 469.5 | 655.6 | 553.7 | 589.6 |
| 17.0027 | OH | 342.4 | 516.1 | 459.4 | 438.9 |
| 25.0078 | C₂H | 38.90 | 40.77 | 40.24 | 54.24 |
| 27.9759 | Si | 10 | 10 | 10 | 10 |
| 59.9660 | SiO₂ | 85.72 | 100.7 | 80.52 | 79.27 |
| 60.9741 | SiO₂H | 92.24 | 106.3 | 98.83 | 88.12 |
| 76.9693 | SiO₃H | 56.93 | 73.48 | 59.53 | 56.09 |
| 58.9955 | CH₃SiO | 6.882 | 6.911 | 1.476 | 1.387 |
| 59.9940 | ¹³CH₃SiO | 0.7384 | 0.7256 | 5.700 | 4.945 |
| 74.9910 | CH₃SiO₂ | 16.72 | 17.79 | 1.963 | 1.754 |
| 75.9908 | ¹³CH₃SiO₂ | 1.317 | 1.162 | 13.02 | 11.62 |
| 126.9020 | I | 542.5 | 636.6 | 674.7 | 902.6 |

TABLE 3
Normalized intensities of various positive ions of interest
(Normalized relative to ²⁸Si, × 10000)

| m/z | Species | Si/CH₃I | Si/CH₃I | Si/¹³CH₃I | Si/¹³CH₃I |
|---|---|---|---|---|---|
| 15.0235 | CH₃ | 299.3 | 281.5 | 238.8 | 148.3 |
| 16.0270 | ¹³CH₃ | 4.698 | 4.342 | 100.00 | 45.17 |
| 18.0349 | NH₄ | 365.1 | 236.1 | 292.1 | 88.59 |
| 27.9757 | Si | 10000 | 10000 | 10000 | 10000 |
| 42.9989 | SiCH₃ | 2576 | 2566 | 731.2 | 463.3 |
| 44.0118 | ¹³CH₃Si | 36.52 | 27.59 | 1743 | 1019 |
| 58.0229 | C₂H₆Si | 65.24 | 66.35 | 26.68 | 16.41 |
| 60.0296 | ¹³C₂H₆Si | 17.10 | 19.64 | 33.70 | 13.13 |
| 59.0324 | C₂H₇Si | 100.6 | 98.49 | 53.65 | 29.19 |
| 61.0340 | ¹³C₂H₇Si | 6.287 | 8.101 | 35.28 | 10.60 |
| 73.0511 | C₃H₉Si | 214.3 | 313.3 | 89.01 | 41.99 |
| 76.0476 | ¹³C₃H₉Si | 0.848 | 1.271 | 39.53 | 7.053 |

TABLE 4
Calculated energies of fragments in kJ/mol. The minimum energy
is the absolute energy of the lowest energy fragment. The other
energies are differences from that energy.

Fragment

| | Singlet HF | Singlet MP2 | Singlet CCSD |
|---|---|---|---|
| Minimum Energy | −861773 | −862312 | −862401 |
| SiCH₃⁺ | 0 | 0 | 0 |
| HSiCH₂⁺ | 223 | 192 | 206 |
| H₂SiCH⁺ | 304 | 360 | 341 |
| H₃SiC⁺ | 526 | 629 | 576 |
| | Triplet HF | Triplet MP2 | Triplet CCSD |
| SiCH₃⁺ | 146 | 212 | 210 |
| HSiCH₂⁺ | 435 | 496 | 492 |
| H₂SiCH⁺ | 202 | 318 | 312 |
| H₃SiC⁺ | 437 | 594 | 567 |

TABLE 5
Calculated energies of fragments in kL/mol. The minimum energy
is the absolute energy of the lowest energy fragment. The other
energies are differences from that energy.

Fragment

| | Singlet HF | Singlet MP2 | Singlet CCSD |
|---|---|---|---|
| Minimum Energy | −964284 | −965233 | −965338 |
| SiCH₂CH₃⁺ | 5 | 13 | 9 |
| HSiCHCH₃⁺ | 5 | 13 | 9 |
| HSiCH₂CH₂⁺ | 19 | 16 | 12 |
| H₂SiCCH₃⁺ | 54 | 59 | 53 |
| H₂SiCHCH₂⁺ | 0.012 | 0.009 | 0.012 |
| H₂SiCH₂CH⁺ | 0 | 0 | 0 |
| H₃SiCCH₂⁺ | 31 | 40 | 34 |
| H₃SiCHCH⁺ | 37 | 37 | 34 |
| H₃SiCH₂C⁺ | 31 | 41 | 34 |
| | Triplet HF | Triplet MP2 | Triplet CCSD |
| SiCH₂CH₃⁺ | 33 | 47 | 41 |
| HSiCHCH₃⁺ | 27 | 42 | 39 |
| HSiCH₂CH₂⁺ | 29 | 35 | 35 |
| H₂SiCCH₃⁺ | 37 | 59 | 53 |
| H₂SiCHCH₂⁺ | 43 | 68 | 60 |
| H₂SiCH₂CH⁺ | 43 | 68 | 60 |
| H₃SiCCH₂⁺ | 54 | 88 | 79 |
| H₃SiCHCH⁺ | 62 | 95 | 86 |
| H₃SiCH₂C⁺ | 55 | 88 | 79 |

TABLE 6
Theoretical calculations of 1-dodecene chemisorbed on Si(100)
through two carbon-silicon bonds. Units of numbers in the table
are either degrees for angles or Ångstroms for distances, as
appropriate. Carbons are numbered from the unsaturated end of
the alkyl chain. Si(1) is bonded to C(1) and Si(2) to C(2).

| | MMFF94 | PM3 | STO-3G | 3-21G* |
|---|---|---|---|---|
| C(1)—Si(1)—Si(2)—C(2) | 19.22 | 9.32 | 9.38 | 5.91 |
| dihedral angle. | | | | |
| Si(1)—C(1)—C(2)—C(3) | 154.77 | 133.54 | 133.64 | 137.34 |
| dihedral angle. | | | | |
| C(1)—C(2)—C(4)-90° | 8.36 | 9.99 | 9.95 | 8.20 |
| angle. | | | | |
| C(2)—C(4)—C(6) | 178.82 | 179.32 | 179.27 | 179.48 |
| angle. | | | | |
| C(1)—C(2)—C(3) | 114.96 | 115.78 | 115.77 | 114.46 |
| angle. | | | | |
| C(1)—Si(1) | 1.866 | 1.913 | 1.913 | 1.903 |
| C(2)—Si(2) | 1.891 | 1.939 | 1.938 | 1.918 |
| Si(1)—Si(2) | 2.585 | 2.399 | 2.399 | 2.352 |
| C(1)—C(2) | 1.563 | 1.501 | 1.502 | 1.582 |
| C(2)—C(3) | 1.536 | 1.508 | 1.508 | 1.548 |
| C(3)—C(4) | 1.532 | 1.522 | 1.522 | 1.547 |

TABLE 7
Theoretical calculations of 1-dodecyne chemisorbed on Si(100)
through two carbon-silicon bonds. Units of numbers in the table
are either degrees for angles or Ångstroms for distances, as
appropriate. Carbons are numbered from the unsaturated end of
the alkyl chain. Si(1) is bonded to C(1) and Si(2) to C(2).

| | MMFF94 | PM3 | STO-3G | 3-21G* |
|---|---|---|---|---|
| C(1)—Si(1)—Si(2)—C | −0.03 | −0.04 | −0.072 | 0.00 |
| (2) dihedral angle | | | | |
| Si(1)—C(1)—C(2)—C | −179.92 | −179.88 | −179.88 | −179.99 |
| (3) dihedral angle | | | | |
| C(1)—C(2)—C(4)- | 7.36 | 7.27 | 7.28 | 5.11 |
| 90° angle. | | | | |
| C(2)—C(4)—C(6) | 179.34 | 177.71 | 177.74 | 178.09 |
| angle. | | | | |
| C(1)—C(2)—C(3) | 129.76 | 130.79 | 130.79 | 127.66 |
| angle. | | | | |
| C(1)—Si(1) | 1.856 | 1.837 | 1.837 | 1.871 |
| C(2)—Si(2) | 1.893 | 1.859 | 1.860 | 1.888 |
| Si(1)—Si(2) | 2.529 | 2.439 | 2.439 | 2.253 |
| C(1)—C(2) | 1.363 | 1.331 | 1.330 | 1.328 |
| C(2)—C(3) | 1.581 | 1.472 | 1.472 | 1.532 |
| C(3)—C(4) | 1.526 | 1.522 | 1.521 | 1.546 |

What is claimed is:

1. A method of functionalizing the surface of a material, the method comprising scribing the surface of the material in the presence of a reactive species to produce scribed portions of the surface, wherein the reactive species reacts with the scribed portions of the surface, and wherein the material is a semiconductor or an insulator.

2. The method of claim 1, wherein the reactive species is in the liquid state.

3. The method of claim 1, wherein the reactive species is in the vapor state.

4. The method of claim 1, wherein the reactive species is dissolved in an organic solvent.

5. The method of claim 1, wherein the material is scribed in the presence of air.

6. The method of claim 1, wherein the material is scribed under a pressure of about 760 torr to about 10⁻¹⁰ Torr.

7. The method of claim 1, wherein the material is scribed in an inert atmosphere at about atmospheric pressure.

8. The method of claim 7, wherein the material is scribed in a nitrogen atmosphere.

9. The method of claim 7, wherein the material is scribed in an argon atmosphere.

10. The method of claim 1, wherein the reactive species is selected from the group consisting of alkenes, alkynes, alcohols, thiols, amines, halides, aldehydes, ketones, amides, carboxylic acids, carboxylic acid esters, acrylates, methacrylates, vinyl ethers, acrylamides, azides, nitrites, dienes, trienes, phosphines, isocyanates, isothiocyanates, silanols, oximes, diazo, epoxides, nitro, sulfate, sulfonate, phosphate, phosphonate, anhydrides, guanadino, phenolics, acid chlorides, imines, diols, triols, hydrazones, hydrazines, disulfides, sulfides, sulfones, sulfoxides, peroxides, ureas, thioureas, carbamates, diazonium, azo, DNA, RNA, protein, carbohydrates, lipids, and styrenics.

11. The method of claim 10, wherein the reactive species has at least one chiral center.

12. The method of claim 1, wherein the reactive species is an inorganic compound.

13. The method of claim 10, wherein the reactive species is a 1-alkene.

14. The method of claim 10, wherein the reactive species is a 1-alkyne.

15. The method of claim 10, wherein the reactive species is a terminal alcohol of the form HO(CH₂)ₙCH₃, where n is 0 or greater.

16. The method of claim 10, wherein the reactive species is a terminal alkyl halide of the form X(CH2)ₙCH₃, where n is 0 or greater and X is I, Br, or C1.

17. The method of claim 10, wherein the reactive species is a terminal carboxylic acid of the form HOOC(CH₂)ₙH, where n is 0 or greater.

18. The method of claim 1, wherein the reactive species contains two or more functional groups, at least one of which is capable of reacting with the surface.

19. The method of claim 18, wherein at least two functional groups are different.

20. The method of claim 18, wherein the reactive species is of the form X(CH₂)ₙY, where n is an integer greater than 0 and X and Y represent functional groups.

21. The method of claim 18, wherein the functional groups are attached to a phenyl ring.

22. The method of claim 1, wherein the material is scribed under a mixture of two or more reactive species.

23. The method of claim 1, wherein the scribed portions of the surface contain free radicals.

24. The method of claim 1, wherein the scribed portions of the surface contain double bonds.

25. The method of claim 1, wherein the material contains silicon.

26. The method of claim 25, wherein the material consists essentially of silicon.

27. The method of claim 1, wherein the material is quartz.

28. The method of claim 1, wherein the material contains germanium.

29. The method of claim 1, wherein the material contains diamond.

30. The method of claim 1, wherein the material is a polymer.

31. The method of claim 1, wherein the material is silicon carbide.

32. The method of claim 1, wherein the material is silicon nitride.

33. The method of claim 1, wherein the material is hydrogen-terminated silicon.

34. The method of claim 1, wherein the material has a curved surface.

35. The method of claim 1, wherein the material is scribed with an instrument that makes a mark that is 0.1 mm to 1 cm wide in a single pass.

36. The method of claim 1, wherein the material is scribed with a tungsten-carbide ball.

37. The method of claim 33, wherein the material is scribed with a tungsten-carbide ball.

38. The method of claim 1, wherein the material is scribed with an AFM tip.

39. The method of claim 33, wherein the material is scribed with an AFM tip.

40. The method of claim 1, wherein the material is scribed with a laser.

41. A method of functionalizing the surface of a material, the method comprising:
(a) exposing the surface to a mixture of an inert gas and a reactive species; and
(b) scribing the surface of the material in the presence of the mixture to produce scribed portions of the surface, wherein the reactive species reacts with the scribed portions of the surface, and wherein the material is a semiconductor or an insulator.

42. The method of claim 41, wherein the mixture is directed onto the surface in a gas stream.

43. The method of claim 41, wherein the inert gas is nitrogen.

44. The method of claim 41, wherein the inert gas is argon.

45. A method of forming a pattern on a surface of a material, the method comprising scribing a pre-determined pattern on the surface in the presence of a reactive species to form scribed portions of the surface, wherein the reactive species reacts with the scribed portions of the surface, and wherein the material is a semiconductor or an insulator.

46. The method of claim 45, wherein the pattern is a grid.

47. The method of claim 45, wherein the pattern contains patches.

48. The method of claim 45, wherein the pattern contains lines.

49. The method of claim 45, wherein the material contains silicon.

50. The method of claim 49, wherein the material is hydrogen-terminated silicon.

51. The method of claim 45, wherein the material is quartz.

52. The method of claim 45, wherein the material is diamond.

53. The method of claim 45, wherein the material is a polymer.

54. A method of functionalizing the surface of a material, the method comprising:
(a) scribing the surface of the material in an inert atmosphere to produce scribed portions of the surface, wherein the material is a semiconductor or an insulator; and
(b) exposing the scribed surface to a reactive species, wherein the reactive species reacts with the scribed portions of the surface.

55. The method of claim 54, wherein the material is scribed under a nitrogen atmosphere.

56. The method of claim 54, wherein the material is scribed under an argon atmosphere.

57. The method of claim 54, wherein the material is scribed under reduced pressure.

58. The method of claim 54, wherein the material is scribed with a diamond scribe.

59. The method of claim 54, wherein the material is scribed with a beam of ions.

60. The method of claim 54, wherein the material is scribed with a beam of energetic neutral species.

61. The method of claim 54, wherein the material is scribed with a laser.

62. The method of claim 54, wherein the surface is patterned.

63. The method of claim 62, wherein the patterned surface is used for chromatography or electrophoresis.

64. A composition comprising a material containing a pattern scribed on its surface, wherein the pattern comprises molecules covalently bonded to the surface, wherein the molecules may contain functional groups, and wherein the material is a semiconductor or an insulator.

65. The composition of claim 64, wherein the material is silicon.

66. The composition of claim 64, wherein the material is quartz.

67. The composition of claim 64, wherein the pattern is a grid.

68. The composition of claim 64, wherein the pattern contains patches.

69. The composition of claim 64, wherein the pattern contains lines.

70. A composition comprising a material containing a pattern scribed on its surface, wherein the pattern comprises polymer chains covalently bonded to the surface, wherein the material is a semiconductor or an insulator.

71. A method of performing a chemical reaction, the method comprising:
(a) providing a surface containing at least one hydrophobic corral;
(b) depositing a drop of solution into each corral; and
(c) maintaining the surface under conditions and for a time sufficient to allow the reaction to proceed.

72. The method of claim 71, wherein the surface contains Si—C bonds.

73. A method of performing a chemical reaction, the method comprising:
(a) providing a surface containing one or more functionalized, scribed regions;
(b) depositing a reactant onto at least one of the regions; and
(c) maintaining the surface under conditions and for a time sufficient to allow the reaction to proceed.

74. The method of claim 73, wherein the reactant is CrO₃/H₂SO₄.

75. The method of claim 73, wherein the reactant is Cl₂ gas that is illuminated with UV light.

76. The method of claim 73, wherein the reactant is Cl₂ gas and at least one other reactive gas that is illuminated with UV light.

77. The method of claim 73, wherein the reactant is photobiotin.

78. A method of functionalizing multiple regions of a surface, the method comprising:
(a) providing a surface containing a grid of hydrophobic corrals;
(b) depositing at least two different solutions into at least two hydrophobic corrals;
(c) maintaining the surface under conditions and for a time sufficient to allow surface functionalization to proceed.

79. The method of claim 78, wherein aliquots of two or more liquids are added to a hydrophobic corral.

80. The method of claim 79, wherein the liquids are mixed.

81. The method of claim 78, wherein the surface is cleaned after surface functionalization.

82. A method of performing reactions in droplets of solutions in multiple regions of a surface, the method comprising:
(a) providing a surface containing a grid of hydrophobic corrals;
(b) depositing at least two different solutions into at least different hydrophobic corrals;
(c) maintaining the surface under conditions and for a time sufficient to allow the reactions to occur.

83. The method of claim 82, wherein the droplets are analyzed with an analytical technique.

84. The method of claim 82, wherein aliquots of at least two different liquids are added to the same hydrophobic corral.

85. The method of claim 84, wherein the liquids are mixed.

86. A method of functionalizing different regions of a material, wherein the material is a semiconductor or insulator, the method comprising:
(a) wetting the dry surface of the material with a reactive compound;
(b) scribing a region of the surface;
(c) removing the reactive compound; and
(d) repeating steps (a)-(c) using a different reactive compound and scribing in a region where scribing has not taken place until the desired functionalization is complete.

87. A composition comprising a material containing an array of hydrophobic corrals, wherein the interior regions of the hydrophobic corrals are functionalized.

88. The composition of claim 87, wherein the interior regions contain DNA.

89. The composition of claim 87, wherein the interior regions contain RNA.

90. The composition of claim 87, wherein the interior regions contain proteinaceous materials.

91. The composition of claim 87, wherein the interior regions contain a carbohydrate.

92. The composition of claim 87, wherein the interior regions contain a lipid.

93. The composition of claim 87, wherein the interior regions contain a polymer.

94. The composition of claim 87, wherein the interior regions contain a silane coupling agent.

95. The composition of claim 87, wherein the interior regions contain a polyelectrolyte multilayer.

96. The composition of claim 87, wherein the interior regions contain a monolayer.

97. The method of claim 1, wherein the material is coated with a silane coupling agent.

98. The method of claim 1, wherein the material is coated with a polyelectrolyte multilayer.

99. The method of claim 1, wherein the material is coated with a monolayer.
